(19) United States
(12) Patent Application Publication
(10) Pub. No.: US 2026/0307536 A1
(43) Pub. Date: Oct. 8, 2026

(54) TEMPERATURE ADJUSTMENT SYSTEM

(71) Applicant: MIKUNI CORPORATION, Tokyo (JP)

(72) Inventors: Yuichi KOIKE, Kanagawa (JP); Kazufumi YOSHIYA, Kanagawa (JP); Shoichi ISHIGUCHI, Kanagawa (JP); Tomonori KAKIZOE, Kanagawa (JP)

(73) Assignee: MIKUNI CORPORATION, Tokyo (JP)

(21) Appl. No.: 19/449,464

(22) Filed: Jan. 15, 2026

(30) Foreign Application Priority Data
Apr. 3, 2025 (JP) 2025-061890

(51) Int. Cl. B60L 58/24; B60H 1/00; B60H 1/32; B60K 1/00; B60K 1/02; B60K 17/356; B60L 53/62; H01M 10/613; H01M 10/625; H01M 10/6551; H01M 10/6569; H01M 10/6571

(52) U.S. Cl. CPC B60L 58/24; B60H 1/00278; B60K 1/02; H01M 10/613; H01M 10/625; H01M 10/6551; H01M 10/6569; H01M 10/6571; B60H 2001/00307; B60H 1/32284; B60K 2001/005; B60K 2001/006; B60K 17/356; B60L 53/62; B60L 2220/42; B60L 2240/545; H01M 2220/20

(57) ABSTRACT

A temperature adjustment system includes: a battery; a first heat medium passage for performing heat exchange with the battery; a drive motor; a second heat medium passage for performing heat exchange with the drive motor; a refrigerant passage through which a refrigerant circulates; a third heat medium passage for performing heat exchange with the refrigerant; and one multi-way switching valve opening and closing respective inlets and outlets of the first heat medium passage, the second heat medium passage, and the third heat medium passage. An electric heater heating a heat medium is disposed at the first heat medium passage upstream of the battery. At a predetermined mixing switching position, the multi-way switching valve mixes at least the heat medium flowing through the first heat medium passage and the heat medium flowing through the second heat medium passage to mix the heat media having state quantities different from each other.

### CROSS-REFERENCE TO RELATED APPLICATION

This application claims the priority benefit of Japan application serial no. 2025-061890, filed on Apr. 3, 2025. The entirety of the above-mentioned patent application is hereby incorporated by reference herein and made a part of this specification.

### BACKGROUND

### Technical Field

The present disclosure relates to a temperature adjustment system that is mounted on an electric vehicle or the like and performs heat exchange among various functional components (a battery, a drive motor, etc.), a cooling water, or a refrigerant to adjust the temperature of the various functional components to a desired temperature, in a configuration including an HVAC system that performs heating, ventilation, air conditioning, etc. in a vehicle cabin.

### Related Art

As a conventional temperature adjustment system, a vehicle thermal management system is known (e.g., refer to Patent Document 1 (U.S. Pat. No. 11,807,067)). The vehicle thermal management system includes a vehicle heat pump system having an electric cabin heater, a battery system cooling loop for performing heat exchange with a battery, a drivetrain cooling loop including a heat exchanger that performs heat exchange with oil of a drive motor, and one switching valve (eight-way valve) that is connected to both the battery system cooling loop and the drivetrain cooling loop and has four switching modes. The vehicle thermal management system can perform heating of the battery and assist in room heating indoors by utilizing heat generated by the drive motor.

In such a system, since only exhaust heat of the drive motor is utilized as the heat source for heating, time is required for heating the battery and heating the refrigerant for room heating in the vehicle cabin. Particularly, when the temperature of the refrigerant is low, the capability of warming the vehicle cabin decreases, and instead, electric power is consumed by the compressor, and as a result, electric power stored in the battery is consumed excessively.

In addition, when heating the battery, the system is configured to utilize, for heating, the exhaust heat of the drive motor and the heat of the high-temperature refrigerant via a water-cooled condenser. Therefore, although the time required to heat the battery to a target temperature is shortened, an overshoot exceeding the target temperature may occur, the frequency of switching to a cooling mode may increase, and complication in control and instability in the battery temperature may arise.

In addition, as another temperature adjustment system, a vehicle thermal management system is known (e.g., refer to Patent Document 2 (Japanese Patent Application Laid-Open No. 2024-63729)). The vehicle thermal management system includes: a refrigerant circuit in which a refrigerant circulates and which has an indoor heat exchanger performing heat exchange between the refrigerant and indoor air; a heat medium circuit in which a heat medium (cooling water) circulates to adjust the temperature of a battery and a drive motor; a refrigerant-heat medium heat exchanger that performs heat exchange between the refrigerant and the heat medium; and a control unit that controls the operations of the refrigerant circuit and the heat medium circuit. In the vehicle thermal management system, a battery warm-up mode specialized in a function of warming the battery to a desired temperature and a room-heating assist mode specialized in a function of warming the refrigerant that contributes to heating of the vehicle cabin are individually provided as control modes.

In such a system, assuming that the vehicle is to be moved from a stopped state at an extremely low temperature, e.g., −10° C. or lower, the battery warm-up mode and the room-heating assist mode cannot be used simultaneously. In addition, the heat medium circuit includes multiple switching valves, and each of the switching valves is driven by the control unit to control the flow of the heat medium, so the number of components is large and the structure is complex.

Furthermore, as another temperature adjustment system, a temperature control system is known (e.g., refer to Patent Document 3 (Japanese Patent No. 7053906)). The temperature control system includes a refrigeration cycle circuit in which a refrigerant circulates and a cooling water circuit in which a cooling water circulates. The refrigeration cycle circuit includes a compressor, a heat dissipation device that heats air for air conditioning with heat of the refrigerant, an outdoor heat exchanger that performs heat exchange between the refrigerant and outside air, and a cooling water-refrigerant heat exchanger. The cooling water circuit includes an electric hot water heater that heats the cooling water, an electric pump, and a battery heat exchanger that heats a battery, and heat exchange can be performed between the refrigerant and the cooling water in the cooling water-refrigerant heat exchanger.

In such a system, since the cooling water circuit does not include a drive motor or the like, heat generated by the drive motor and the like cannot be utilized, and cooling of the drive motor and the like cannot be performed, either.

### SUMMARY

A temperature adjustment system of an embodiment of the present disclosure is configured to include: a battery; a first heat medium passage through which a heat medium for performing heat exchange with the battery flows; a drive motor driving wheels; a second heat medium passage through which a heat medium for performing heat exchange with the drive motor flows; a refrigerant passage through which a refrigerant circulates; a third heat medium passage through which a heat medium for performing heat exchange with the refrigerant flows; and one multi-way switching valve performing opening and closing operations with respect to respective inlets and outlets of the first heat medium passage, the second heat medium passage, and the third heat medium passage. An electric heater heating the heat medium is disposed at the first heat medium passage upstream of the battery. At a predetermined mixing switching position, the multi-way switching valve mixes at least the heat medium flowing through the first heat medium passage and the heat medium flowing through the second heat medium passage to mix the heat media having state quantities different from each other.

In the temperature adjustment system, at the mixing switching position, the multi-way switching valve may cause the heat medium flowing out from the outlet of the first heat medium passage to flow into the inlet of the first heat medium passage and the inlet of the second heat medium passage, and cause the heat medium flowing out from the outlet of the second heat medium passage to flow into the inlet of the first heat medium passage and the inlet of the second heat medium passage.

In the temperature adjustment system, at the mixing switching position, the multi-way switching valve may connect the outlet of the first heat medium passage to the inlet of the third heat medium passage, connect the outlet of the third heat medium passage to the inlet of the first heat medium passage and the inlet of the second heat medium passage, and connect the outlet of the second heat medium passage to the inlet of the first heat medium passage and the inlet of the second heat medium passage.

In the temperature adjustment system, a first refrigerant-heat medium heat exchanger performing heat exchange between the refrigerant circulating through the refrigerant passage and the heat medium may be disposed at the second heat medium passage. A second refrigerant-heat medium heat exchanger performing heat exchange between the refrigerant circulating through the refrigerant passage and the heat medium may be disposed at the third heat medium passage. A compressor compressing the refrigerant, an on-off valve, and an expansion valve may be disposed at the refrigerant passage, the compressor being disposed upstream of the first refrigerant-heat medium heat exchanger and downstream of the second refrigerant-heat medium heat exchanger, the on-off valve being disposed upstream of the first refrigerant-heat medium heat exchanger, and the expansion valve being disposed upstream of the second refrigerant-heat medium heat exchanger.

In the temperature adjustment system, the on-off valve may allow flow of the refrigerant at the mixing switching position. The expansion valve may allow flow of the refrigerant at the mixing switching position.

The temperature adjustment system may further include: a radiator dissipating heat to outside air; and a fourth heat medium passage through which a heat medium for performing heat exchange via the radiator flows. At the mixing switching position, the multi-way switching valve may close an inlet and an outlet of the fourth heat medium passage.

In the temperature adjustment system, a first electric pump pumping the heat medium may be disposed at the first heat medium passage. The electric heater may be a PTC heater.

In the temperature adjustment system, a vehicle control unit performing control of a vehicle and an onboard charger charging the battery from outside may be disposed at the first heat medium passage to perform heat exchange with the heat medium.

In the temperature adjustment system, a second electric pump pumping the heat medium and an oil heat exchanger transferring heat generated by the drive motor to the heat medium via oil may be disposed at the second heat medium passage.

In the temperature adjustment system, a third electric pump circulating the oil may be disposed at an oil passage between the drive motor and the oil heat exchanger.

In the temperature adjustment system, the drive motor may include a rear drive motor driving rear wheels of a vehicle and a front drive motor driving front wheels of the vehicle. The third electric pump and the oil heat exchanger may be disposed for each of the rear drive motor and the front drive motor.

In the temperature adjustment system, a converter and an inverter may be disposed at the second heat medium passage to perform heat exchange with the heat medium.

In the temperature adjustment system, a reservoir tank through which the heat medium passes may be disposed at the second heat medium passage.

According to the temperature adjustment system having the above configuration, an overshoot exceeding the upper limit temperature when warming the battery can be suppressed, the frequency of switching between the heating mode and the cooling mode can be reduced to prevent complication in control, and the temperature of the battery can be stabilized.

### BRIEF DESCRIPTION OF THE DRAWINGS

FIG. 1 is a system diagram showing a temperature adjustment system according to an embodiment of the present disclosure.

FIG. 2 is an external perspective view of a multi-way switching valve device applied to the temperature adjustment system according to an embodiment, as viewed obliquely from above in one direction.

FIG. 3 is an external perspective view of the multi-way switching valve device applied to the temperature adjustment system according to an embodiment, as viewed obliquely from above in another direction.

FIG. 4 is an external perspective view of the multi-way switching valve device applied to the temperature adjustment system according to an embodiment, as viewed obliquely from below.

FIG. 5 is an exploded perspective view of the multi-way switching valve device applied to the temperature adjustment system according to an embodiment.

FIG. 6 is a perspective view showing a base member forming a part of the multi-way switching valve device.

FIG. 7 is a perspective cross-sectional view of the base member forming a part of the multi-way switching valve device, taken along a plane passing through an axis of a cylindrical recess.

FIG. 8 is a partial plan view of a region of the cylindrical recess of the base member forming a part of the multi-way switching valve device, as viewed from the direction of the axis.

FIG. 9 is a perspective cross-sectional view of the base member forming a part of the multi-way switching valve device, taken along a plane perpendicular to the axis.

FIG. 10 is a perspective cross-sectional view of the base member forming a part of the multi-way switching valve device, taken along a plane perpendicular to the axis.

FIG. 11 is an external perspective view of a multi-way switching valve forming a part of the multi-way switching valve device, as viewed obliquely from above.

FIG. 12 is an external perspective view of the multi-way switching valve forming a part of the multi-way switching valve device, as viewed obliquely from below.

FIG. 13 is a plan view of the multi-way switching valve forming a part of the multi-way switching valve device, as viewed from above.

FIG. 14 is a cross-sectional view of the multi-way switching valve forming a part of the multi-way switching valve device, taken along a plane perpendicular to the axis in a region of a first outer circumferential surface (upper section).

FIG. 15 is a cross-sectional view of the multi-way switching valve forming a part of the multi-way switching valve device, taken along a plane perpendicular to the axis in a region of a second outer circumferential surface (lower section).

FIG. 16 is a cross-sectional view of the multi-way switching valve forming a part of the multi-way switching valve device, taken along a plane perpendicular to the axis in an intermediate region between the first outer circumferential surface (upper section) and the second outer circumferential surface (lower section).

FIG. 17 is a perspective cross-sectional view of the multi-way switching valve forming a part of the multi-way switching valve device, taken along a plane perpendicular to the axis in a region of the first outer circumferential surface (upper section).

FIG. 18 is a perspective view showing a seal member and a spacer member forming a part of the multi-way switching valve device.

FIG. 19 is a partial cross-sectional view of the multi-way switching valve device, taken along a plane including the axis in a region of the multi-way switching valve and a drive unit.

FIG. 20 is a perspective view showing inside of the drive unit forming a part of the multi-way switching valve device.

FIG. 21 is a schematic diagram schematically showing a first refrigerant-heat medium heat exchanger and a second refrigerant-heat medium heat exchanger forming a part of the multi-way switching valve device.

FIG. 22 is a system diagram showing flows of fluids (heat medium and refrigerant) in the temperature adjustment system when the multi-way switching valve is at a first switching position in the multi-way switching valve device.

FIG. 23 is a partial cross-sectional view taken in the regions of the first outer circumferential surface (upper section) and the second outer circumferential surface (lower section), showing a state of the multi-way switching valve when the multi-way switching valve is at the first switching position in the multi-way switching valve device.

FIG. 24 is a system diagram showing a flow of the fluid (heat medium) in the temperature adjustment system when the multi-way switching valve is at a second switching position in the multi-way switching valve device.

FIG. 25 is a partial cross-sectional view taken in the regions of the first outer circumferential surface (upper section) and the second outer circumferential surface (lower section), showing a state of the multi-way switching valve when the multi-way switching valve is at the second switching position in the multi-way switching valve device.

FIG. 26 is a system diagram showing a flow of the fluid (heat medium) in the temperature adjustment system when the multi-way switching valve is at a third switching position in the multi-way switching valve device.

FIG. 27 is a partial cross-sectional view taken in the regions of the first outer circumferential surface (upper section) and the second outer circumferential surface (lower section), showing a state of the multi-way switching valve when the multi-way switching valve is at the third switching position in the multi-way switching valve device.

FIG. 28 is a system diagram showing a flow of the fluid (heat medium) in the temperature adjustment system when the multi-way switching valve is at a fourth switching position in the multi-way switching valve device.

FIG. 29 is a partial cross-sectional view taken in the regions of the first outer circumferential surface (upper section) and the second outer circumferential surface (lower section), showing a state of the multi-way switching valve when the multi-way switching valve is at the fourth switching position in the multi-way switching valve device.

FIG. 30 is a system diagram showing flows of the fluids (heat medium and refrigerant) in the temperature adjustment system when the multi-way switching valve is at a fifth switching position (mixing switching position for mixing fluids (heat medium) having different state quantities) in the multi-way switching valve device.

FIG. 31 is a partial cross-sectional view taken in the regions of the first outer circumferential surface (upper section) and the second outer circumferential surface (lower section), showing a state of the multi-way switching valve when the multi-way switching valve is at the fifth switching position in the multi-way switching valve device.

FIG. 32 is a graph showing results of simulating a time that the battery can be maintained in a range of a management temperature (target temperature) at the fifth switching position (mixing switching position), as a comparison between the present disclosure and the conventional art.

FIG. 33 is a partial cross-sectional view taken along a plane perpendicular to the axis, showing a relationship between an abutting part of the multi-way switching valve and a stopper of the base member.

FIG. 34 is a table showing fifteen operation modes, including an operation mode 1 to an operation mode 15, at the five switching positions in the temperature adjustment system according to an embodiment.

### DESCRIPTION OF THE EMBODIMENTS

Embodiments of the present disclosure provide a temperature adjustment system capable of suppressing an overshoot exceeding an upper limit temperature when warming a battery, reducing a frequency of switching between a heating mode and a cooling mode, preventing complication in control, and stabilizing a temperature of the battery.

Hereinafter, embodiments of the present disclosure will be described with reference to the accompanying drawings.

A temperature adjustment system according to the present disclosure is applied in an electric vehicle to perform heat exchange among various functional components (e.g., a battery, a drive motor, etc.), a cooling water (e.g., an LLC) as a heat medium, a refrigerant (e.g., a fluorocarbon-based gas), and a cooling water to control the temperature of various functional components to a desired temperature together with air conditioning, in a configuration including an EV air conditioning (HVAC) system that performs heating, ventilation, air conditioning, etc. in a vehicle cabin.

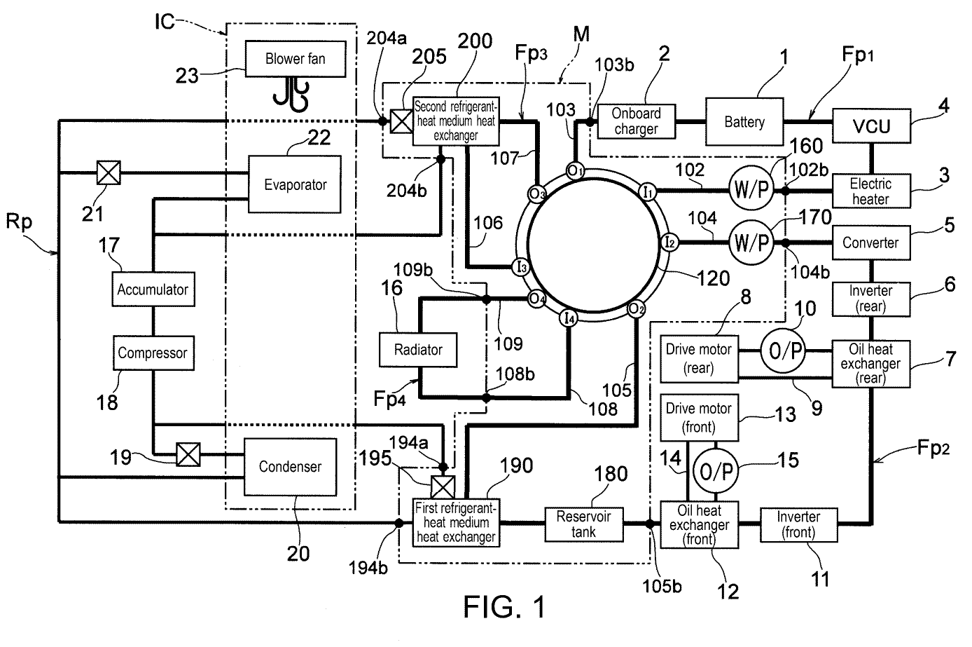

As shown in FIG. 1, the temperature adjustment system according to an embodiment includes: a first heat medium passage Fp₁ as a first fluid passage, a second heat medium passage Fp₂ as a second fluid passage, a third heat medium passage Fp₃ as a third fluid passage, a fourth heat medium passage Fp₄ as a fourth fluid passage, a refrigerant passage Rp, a battery 1, an onboard charger 2, an electric heater 3, a vehicle control unit 4, a converter 5, an inverter 6, an oil heat exchanger 7, a rear drive motor 8, an oil passage 9, an oil pump 10 as a third electric pump, an inverter 11, an oil heat exchanger 12, a front drive motor 13, an oil passage 14, an oil pump 15 as a third electric pump, a radiator 16, an accumulator 17, a compressor 18, an on-off valve 19, a condenser 20, an expansion valve 21, an evaporator 22, a blower fan 23, a multi-way switching valve device M, and other components.

Herein, the condenser 20, the evaporator 22, and the blower fan 23 are disposed in a vehicle cabin IC or in a region communicating with the vehicle cabin IC.

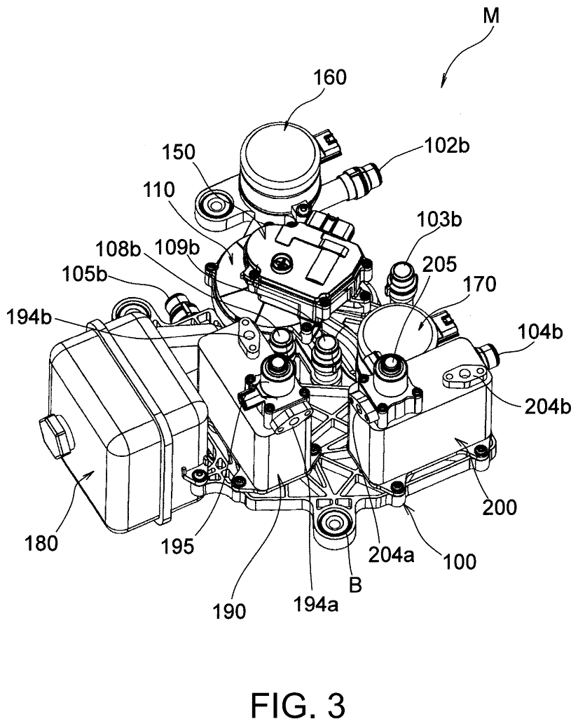

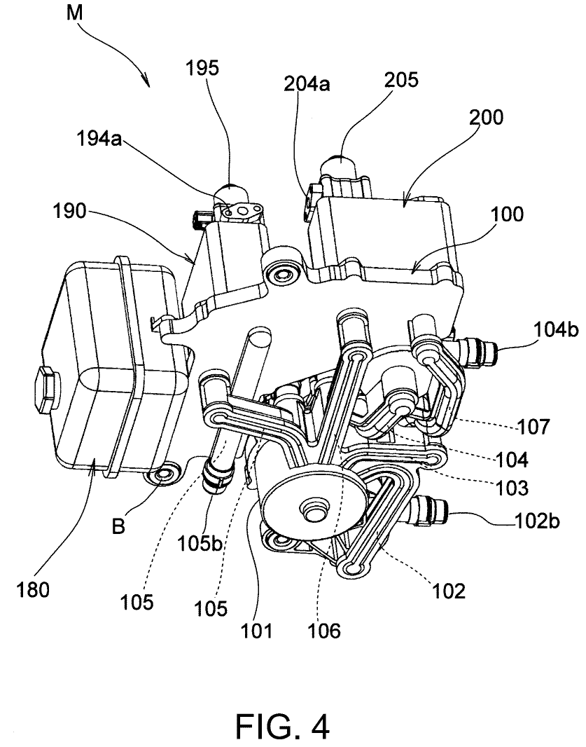

As shown in FIG. 1 to FIG. 5, the multi-way switching valve device M includes a base member 100, a cover member 110, a multi-way switching valve 120, a seal member 130, a spacer member 140, a drive unit 150, a water pump 160 as a first electric pump, a water pump 170 as a second electric pump, a reservoir tank 180, a first refrigerant-heat medium heat exchanger 190, and a second refrigerant-heat medium heat exchanger 200.

The first heat medium passage Fp₁ is configured such that an inlet I₁ and an outlet O₁ of the first heat medium passage Fp₁ face the multi-way switching valve 120 of the multi-way switching valve device M. The water pump 160, the electric heater 3, the vehicle control unit 4, the battery 1, and the onboard charger 2 are disposed at the first heat medium passage Fp₁ sequentially from the inlet I₁ toward the outlet O₁.

The battery 1 is, for example, a high-voltage battery of 300 V to 400 V, and is mainly used as a power source for the rear drive motor 8 and the front drive motor 13. The battery 1 is disposed at a position facing the first heat medium passage Fp₁ via a heat exchange structure (not shown) to be capable of heat exchange with cooling water flowing through the first heat medium passage Fp₁.

As a power source for other electrical components, for example, a low-voltage battery (not shown) of 12 V to 48 V is included.

The onboard charger 2 serves to convert the voltage of, for example, an EV charging station or a household AC power source to a required voltage when charging the battery 1. The onboard charger 2 is disposed at a position facing the first heat medium passage Fp₁ via a heat exchange structure (not shown) to be capable of heat exchange with the cooling water flowing through the first heat medium passage Fp₁.

The electric heater 3 generates heat using the battery 1 as a power source, and is, for example, a PTC (positive temperature coefficient) heater. The electric heater 3 is disposed at a position facing the first heat medium passage Fp₁ to be capable of heat exchange with the cooling water flowing through the first heat medium passage Fp₁. Herein, in the case of using a PTC heater as the electric heater 3, based on its self-adjusting characteristics, with a temperature rise thereof, resistance increases and the flowing current is limited, so waste of power consumption can be reduced.

The vehicle control unit 4 is a control unit that is activated using the low-voltage battery as a power source and performs various controls of the vehicle. The vehicle control unit 4 is disposed at a position facing the first heat medium passage Fp₁ via a heat exchange structure (not shown) to be capable of heat exchange with the cooling water flowing through the first heat medium passage Fp₁.

The second heat medium passage Fp₂ is configured such that an inlet I₂ and an outlet O₂ of the second heat medium passage Fp₂ face the multi-way switching valve 120 of the multi-way switching valve device M. The water pump 170, the converter 5, the inverter 6, the oil heat exchanger 7, the inverter 11, the oil heat exchanger 12, the reservoir tank 180, and the first refrigerant-heat medium heat exchanger 190 are disposed at the second heat medium passage Fp₂ sequentially from the inlet I₂ toward the outlet O₂.

The converter 5 is, for example, a DC-DC converter that steps down the voltage of the battery 1 to a low voltage (e.g., 12 to 48 V) suitable for charging the low-voltage battery. The converter 5 is disposed facing the second heat medium passage Fp₂ via a heat exchange structure (not shown) to be capable of heat exchange with cooling water flowing through the second heat medium passage Fp₂.

The inverter 6 converts direct current to alternating current and steps up the voltage to a high voltage (e.g., 300 to 800 V) to adapt the voltage of the battery 1 to driving of the rear drive motor 8. The inverter 6 is disposed at a position facing the second heat medium passage Fp₂ via a heat exchange structure (not shown) to be capable of heat exchange with the cooling water flowing through the second heat medium passage Fp₂.

The oil heat exchanger 7 serves to transfer the heat generated by the rear drive motor 8 to the cooling water via oil, and is disposed at a position facing the second heat medium passage Fp₂ to be capable of performing heat exchange between the oil and the cooling water flowing through the second heat medium passage Fp₂.

The rear drive motor 8 drives the rear wheels of the vehicle, and is cooled via oil that undergoes heat exchange with cooling water by circulating oil flowing through the oil passage 9 with the oil pump 10. The oil pump 10 is driven using the low-voltage battery as a power source.

The inverter 11 converts direct current to alternating current and steps up the voltage to a high voltage (e.g., 300 to 800 V) to adapt the voltage of the battery 1 to driving of the front drive motor 13. The inverter 11 is disposed at a position facing the second heat medium passage Fp₂ via a heat exchange structure (not shown) to be capable of heat exchange with the cooling water flowing through the second heat medium passage Fp₂.

The oil heat exchanger 12 serves to transfer heat generated by the front drive motor 13 to the cooling water via oil, and is disposed at a position facing the second heat medium passage Fp₂ to be capable of performing heat exchange between the oil and the cooling water flowing through the second heat medium passage Fp₂.

The front drive motor 13 drives the front wheels of the vehicle, and is cooled via oil that undergoes heat exchange with cooling water by circulating oil flowing through the oil passage 14 with the oil pump 15. The oil pump 15 is driven using the low-voltage battery as a power source.

The third heat medium passage Fp₃ is configured such that an inlet I₃ and an outlet O₃ of the third heat medium passage Fp₃ face the multi-way switching valve 120 of the multi-way switching valve device M. The second refrigerant-heat medium heat exchanger 200 is disposed midway at the third heat medium passage Fp₃.

The fourth heat medium passage Fp₄ is configured such that an inlet I₄ and an outlet O₄ of the fourth heat medium passage Fp₄ face the multi-way switching valve 120 of the multi-way switching valve device M. The radiator 16 is disposed midway at the fourth heat medium passage Fp₄.

The radiator 16 dissipates the heat of the cooling water flowing through the fourth heat medium passage Fp₄ to outside air.

The refrigerant passage Rp is provided to pass through the first refrigerant-heat medium heat exchanger 190 and the second refrigerant-heat medium heat exchanger 200. The accumulator 17, the compressor 18, the on-off valve 19, the condenser 20, the expansion valve 21, and the evaporator 22 are disposed at the refrigerant passage Rp.

The accumulator 17 is disposed in the refrigerant passage Rp downstream of the evaporator 22 and upstream of the compressor 18, and functions to separate the refrigerant into gas and liquid and send only the gaseous refrigerant to the compressor 18.

The compressor 18 is driven using the battery 1 as a power source, and compresses the refrigerant to high temperature and high pressure and sends out the compressed refrigerant.

The on-off valve 19 is a solenoid valve driven by the low-voltage battery, and opens and closes the refrigerant passage Rp toward the condenser 20.

The condenser 20 liquefies the high-temperature and high-pressure gaseous refrigerant sent from the compressor 18 and releases heat to outside (inside the vehicle cabin IC).

The expansion valve 21 is a solenoid valve driven by the low-voltage battery, is disposed in the refrigerant passage Rp downstream of the condenser 20 and the first refrigerant-heat medium heat exchanger 190, and rapidly expands the refrigerant to low temperature and low pressure.

The evaporator 22 passes therethrough the low-temperature and low-pressure refrigerant that has passed through the expansion valve 21, and absorbs heat from outside (inside the vehicle cabin IC).

The blower fan 23 is driven by the low-voltage battery, and generates forced convection of air to promote the heat dissipation effect of the condenser 20 and the cooling effect of the evaporator 22 inside the vehicle cabin IC.

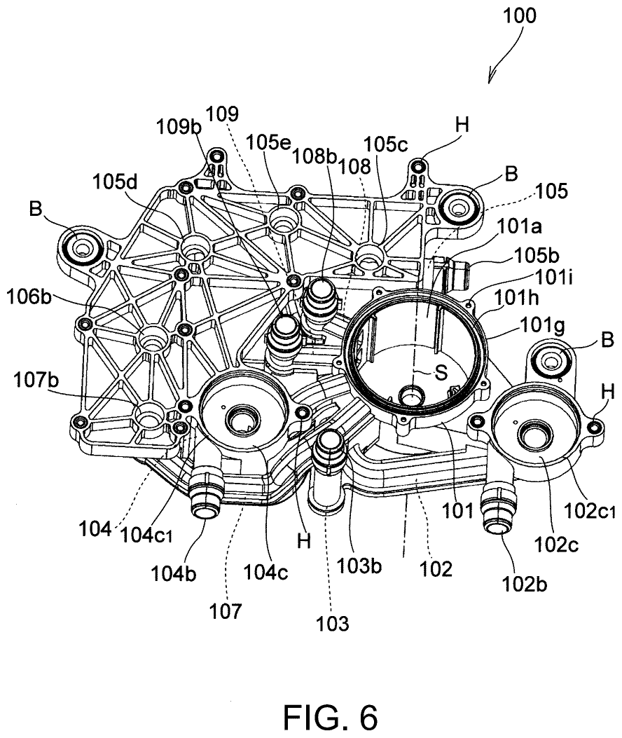

The base member 100 is molded using a resin material, and as shown in FIG. 6 to FIG. 10, includes a cylindrical recess 101 centered on an axis S, a first inlet side passage 102 and a first outlet side passage 103 forming a part of the first heat medium passage Fp₁, a second inlet side passage 104 and a second outlet side passage 105 forming a part of the second heat medium passage Fp₂, a third inlet side passage 106 and a third outlet side passage 107 forming a part of the third heat medium passage Fp₃, a fourth inlet side passage 108 and a fourth outlet side passage 109 forming a part of the fourth heat medium passage Fp₄, multiple (fourteen) embedded screw holes H, and multiple (three) assembled bosses B for mounting.

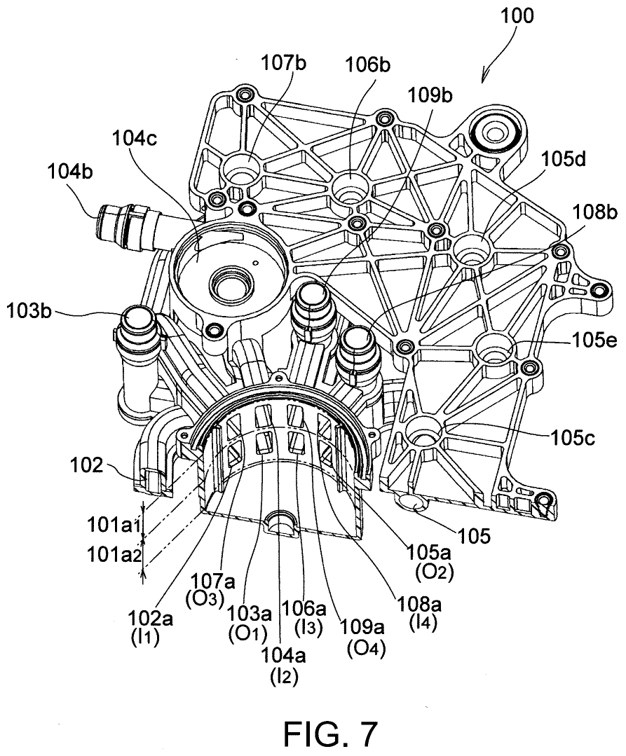

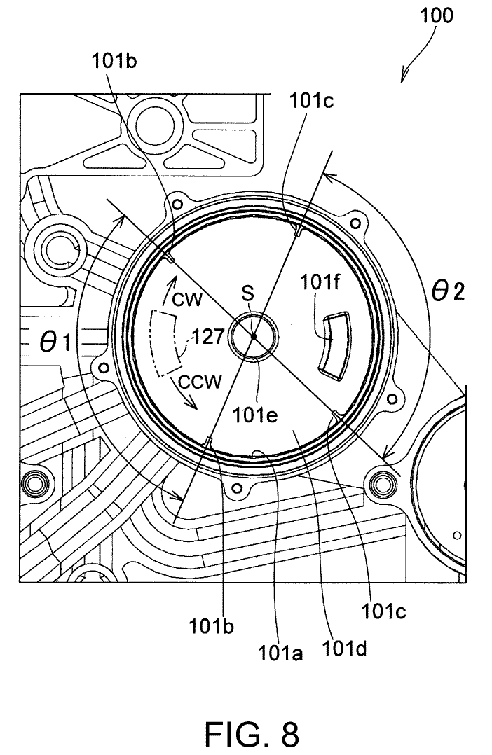

As shown in FIG. 7 and FIG. 8, the cylindrical recess 101 includes multiple openings (inlet I₁, outlet O₁, inlet I₂, outlet O₂, inlet I₃, outlet O₃, inlet I₄, and outlet O₄) in an angular range θ1 (herein, approximately 110 degrees) narrower than a half circumference, on an inner circumferential surface 101a centered on the axis S. Herein, as shown in FIG. 7, the inner circumferential surface 101a includes a first inner circumferential surface 101a₁ and a second inner circumferential surface 101a₂ divided in the axis S direction, four openings (outlet O₃, inlet I₂, outlet O₄, and inlet I₄) are arranged in the circumferential direction on the first inner circumferential surface 101a₁, and four openings (inlet I₁, outlet O₁, inlet I₃, and outlet O₂) are arranged in the circumferential direction on the second inner circumferential surface 101a₂.

In addition, as shown in FIG. 8, the inner circumferential surface 101a includes a pair of protruding strips 101b for positioning the seal member 130 at a position corresponding to the angular range θ1, and a pair of protruding strips 101c for positioning the spacer member 140 in an angular range θ2 (θ1=θ2) located in a region on the opposite side of the angular range θ1 across the axis S.

Furthermore, as shown in FIG. 8, the cylindrical recess 101 includes, on a bottom wall 101d, a bearing recess 101e for supporting an end 121a of a rotating shaft 121 of the multi-way switching valve 120 and a stopper 101f for restricting rotation, and as shown in FIG. 6, includes, on a flange 101g, an annular seal groove 101h for fitting an O-ring Sr₁ and five screw holes 101i.

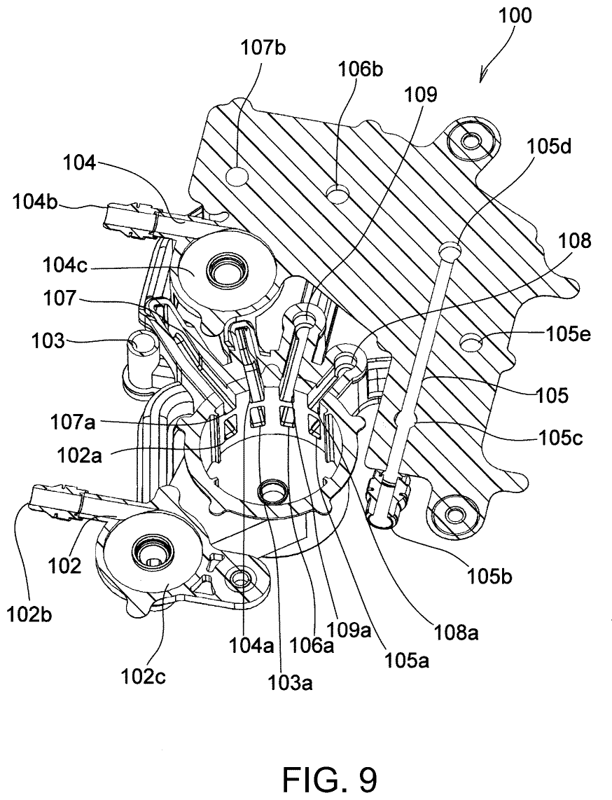

As shown in FIG. 6, FIG. 7, and FIG. 9, the first inlet side passage 102 includes a first inlet 102a through which cooling water flows into the first heat medium passage Fp₁, a first downstream port 102b, and a first pump accommodating recess 102c in midway.

The first inlet 102a is the inlet I₁ opened on the second inner circumferential surface 101a₂.

The first downstream port 102b is connected to the first heat medium passage Fp₁ upstream of the electric heater 3.

The first pump accommodating recess 102c is a region for accommodating the water pump 160, and as shown in FIG. 6, is formed to be parallel to the axis S and opened in the same direction as the cylindrical recess 101, and includes a flange 102c₁ for fixing the water pump 160 at an opening end thereof.

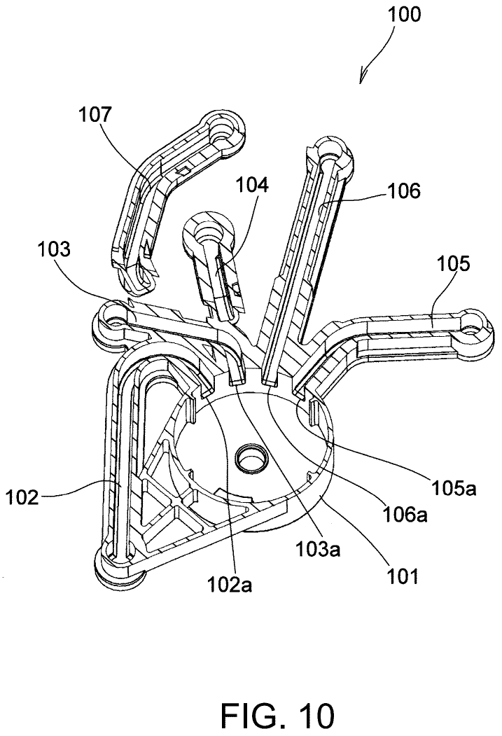

As shown in FIG. 6, FIG. 7, and FIG. 10, the first outlet side passage 103 includes a first outlet 103a through which cooling water flows out from the first heat medium passage Fp into the cylindrical recess 101, and a first upstream port 103b.

The first outlet 103a is the outlet O₁ opened on the second inner circumferential surface 101a₂.

The first upstream port 103b is connected to the first heat medium passage Fp₁ downstream of the onboard charger 2.

As shown in FIG. 6, FIG. 7, and FIG. 9, the second inlet side passage 104 includes a second inlet 104a through which cooling water flows into the second heat medium passage Fp₂, a second downstream port 104b, and a second pump accommodating recess 104c in midway.

The second inlet 104a is the inlet I₂ opened on the first inner circumferential surface 101a₁.

The second downstream port 104b is connected to the second heat medium passage Fp₂ upstream of the converter 5.

The second pump accommodating recess 104c is a region for accommodating the water pump 170, is formed parallel to the axis S and opened in the same direction as the cylindrical recess 101, and includes a flange 104c₁ for fixing the water pump 170 at an opening end thereof.

As shown in FIG. 6, FIG. 7, and FIG. 9, the second outlet side passage 105 includes a second outlet 105a through which cooling water flows out from the second heat medium passage Fp₂ into the cylindrical recess 101, a second upstream port 105b, a branch port 105c parallel to the axis S and opened in the same direction as the cylindrical recess 101 in midway thereof, and two division ports 105d and 105e that are divided from midway downstream of the branch port 105c, parallel to the axis S, and opened in the same direction as the cylindrical recess 101.

The second outlet 105a is the outlet O₂ opened on the second inner circumferential surface 101a₂.

The second upstream port 105b is connected to the second heat medium passage Fp₂ downstream of the oil heat exchanger 12.

The reservoir tank 180 is connected to the branch port 105c to communicate from the axis S direction.

The first refrigerant-heat medium heat exchanger 190 is connected to the two division ports 105d and 105e to communicate from the axis S direction.

As shown in FIG. 6, FIG. 7, and FIG. 10, the third inlet side passage 106 includes a third inlet 106a through which cooling water flows into the third heat medium passage Fp₃, and a third downstream port 106b.

The third inlet 106a is the inlet I₃ opened on the second inner circumferential surface 101a₂.

The third downstream port 106b is formed parallel to the axis S and opened in the same direction as the cylindrical recess 101.

As shown in FIG. 6, FIG. 7, and FIG. 9, the third outlet side passage 107 includes a third outlet 107a through which cooling water flows out from the third heat medium passage Fp₃ into the cylindrical recess 101, and a third upstream port 107b.

The third outlet 107a is the outlet O₃ opened on the first inner circumferential surface 101a₁.

The third upstream port 107b is formed parallel to the axis S and opened in the same direction as the cylindrical recess 101.

The second refrigerant-heat medium heat exchanger 200 is connected to the third downstream port 106b and the third upstream port 107b to communicate from the axis S direction.

As shown in FIG. 6, FIG. 7, and FIG. 9, the fourth inlet side passage 108 includes a fourth inlet 108a through which cooling water flows into the fourth heat medium passage Fp₄, and a fourth downstream port 108b.

The fourth inlet 108a is the inlet I₄ opened on the first inner circumferential surface 101a₁.

The fourth downstream port 108b is formed parallel to the axis S and opened in the same direction as the cylindrical recess 101.

As shown in FIG. 6, FIG. 7, and FIG. 9, the fourth outlet side passage 109 includes a fourth outlet 109a through which cooling water flows out from the fourth heat medium passage Fp₄ into the cylindrical recess 101, and a fourth upstream port 109b.

The fourth outlet 109a is the outlet O₄ opened on the first inner circumferential surface 101a₁.

The fourth upstream port 109b is formed parallel to the axis S and opened in the same direction as the cylindrical recess 101.

A connection part forming a part of the fourth heat medium passage Fp₄ of the radiator 16 is connected to the fourth downstream port 108b and the fourth upstream port 109b to communicate from the axis S direction.

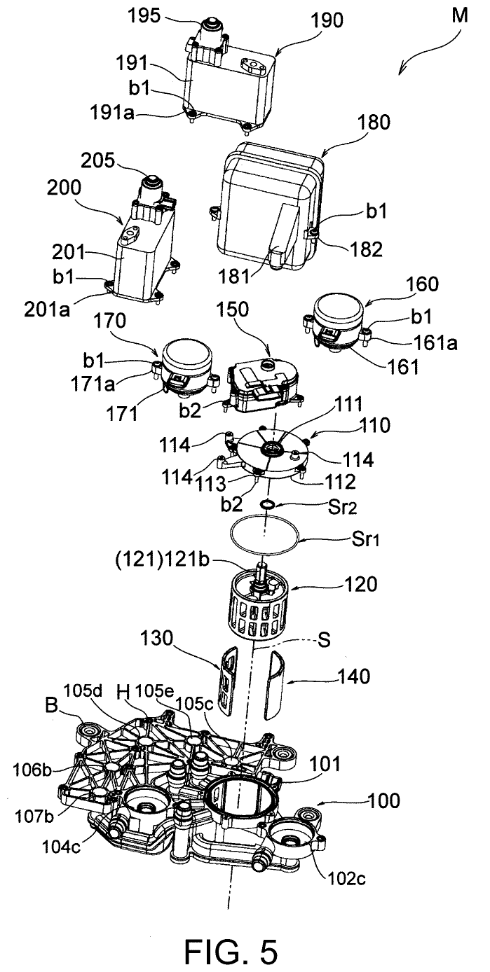

The cover member 110 is formed of a resin material into a substantially disc shape, and serves as a base that covers the cylindrical recess 101 and fixes the drive unit 150. As shown in FIG. 5, the cover member 110 includes a circular hole 111 through which an end 121b of the rotating shaft 121 of the multi-way switching valve 120 passes, an annular joint part 112 joined to the flange 101g of the cylindrical recess 101, five arms 113 formed protruding from the annular joint part 112 and having circular holes through which screws b2 pass, and three bosses 114 having screw holes into which the screws b2 for fixing the drive unit 150 are screwed.

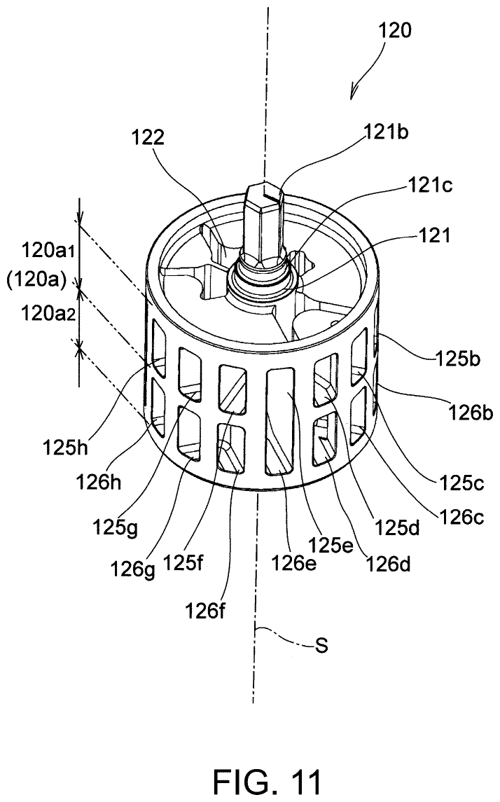

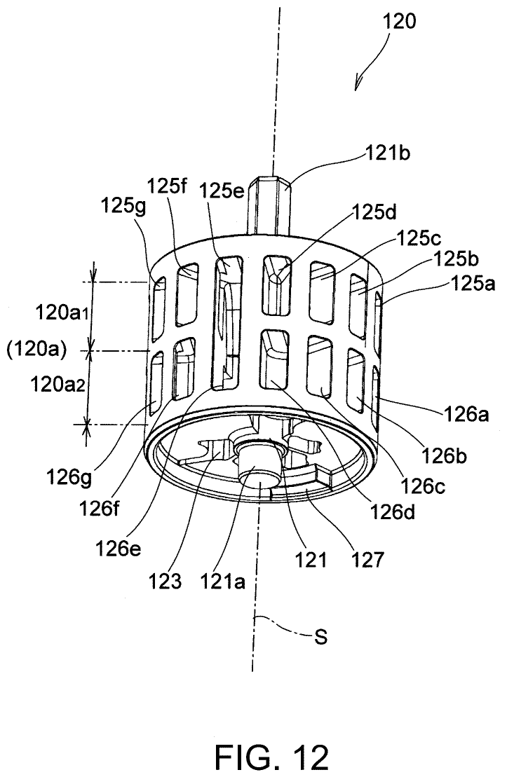

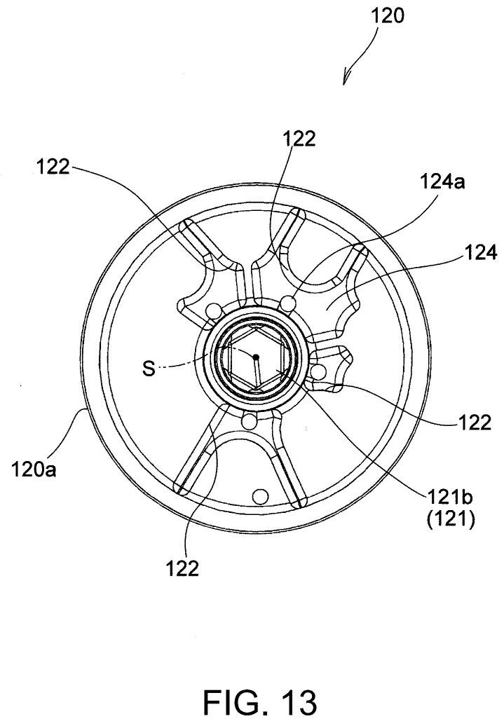

The multi-way switching valve 120 is molded using a resin material into a cylindrical shape centered on the axis S. As shown in FIG. 11 to FIG. 17, the multi-way switching valve 120 includes the rotating shaft 121 centered on the axis S, a first cutout part 122 and a second cutout part 123 that are cut out from both sides in the axis S direction around the rotating shaft 121, a partition wall 124 that partitions the first cutout part 122 and the second cutout part 123, fifteen cutout passage parts 125a to 125o on the first outer circumferential surface 120a₁ and fifteen cutout passage parts 126a to 126o on the second outer circumferential surface 120a₂, which are divided in the axis S direction on the outer circumferential surface 120a, and an abutting part 127 in the vicinity of the second cutout part 123.

The rotating shaft 121 includes respective ends 121a and 121b, and an annular seal part 121c formed on the end 121b side.

The end 121a is inserted into the bearing recess 101e formed in the bottom wall 101d of the cylindrical recess 101 of the base member 100, and is rotatably supported.

The end 121b is connected to a gear 155 of the drive unit 150 through the circular hole of the cover member 110.

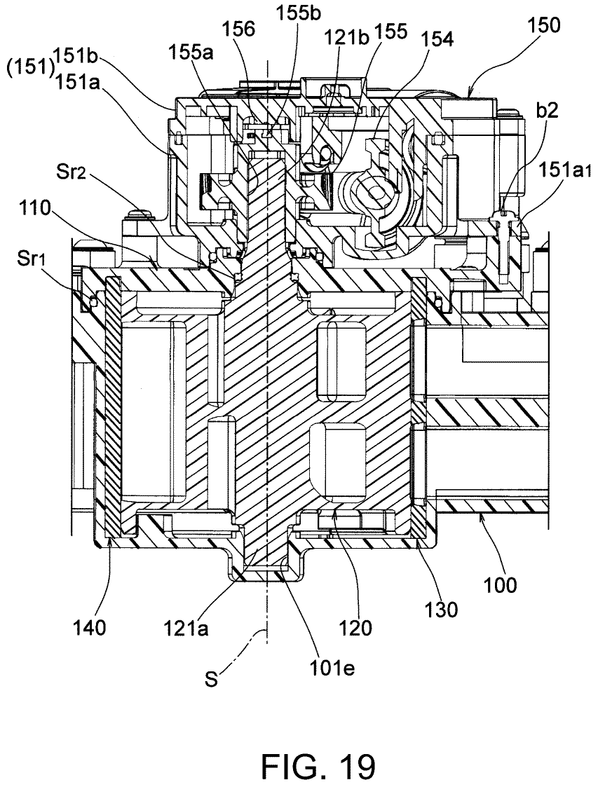

The annular seal part 121c, as shown in FIG. 19, clamps an O-ring Sr₂ together with the cover member 110.

The partition wall 124 includes multiple communication holes 124a that allow the first cutout part 122 and the second cutout part 123 to communicate with each other.

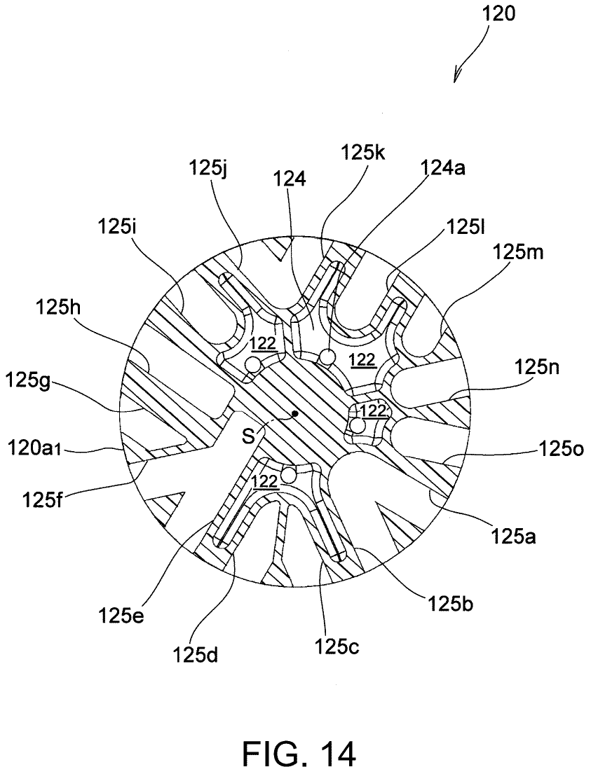

As shown in FIG. 14, the cutout passage parts 125a to 125o are arranged radially and formed to extend toward the center on the rotating shaft 121 side.

In addition, the cutout passage part 125a and the cutout passage part 125b communicate with each other at the inner side, the cutout passage part 125e and the cutout passage part 125f communicate with each other at the inner side, and the cutout passage part 125j and the cutout passage part 125k communicate with each other at the inner side.

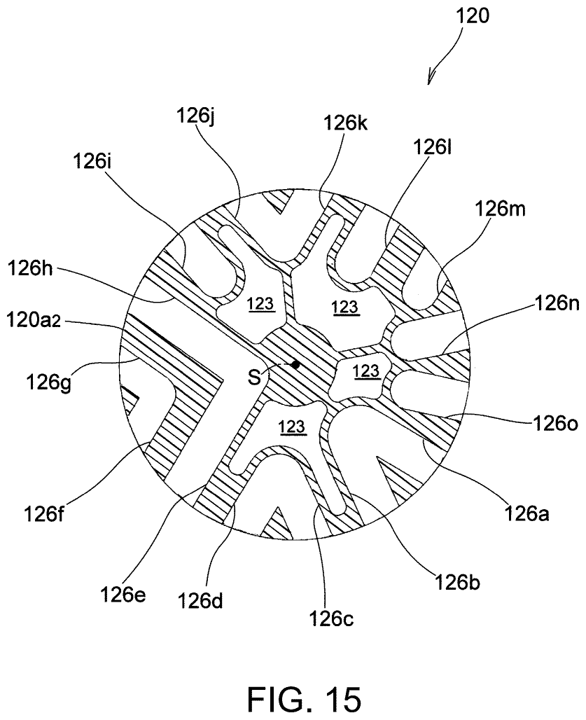

As shown in FIG. 15, the cutout passage parts 126a to 126o are arranged radially and formed to extend toward the center on the rotating shaft 121 side.

In addition, the cutout passage part 126a and the cutout passage part 126b communicate with each other at the inner side, the cutout passage part 126c and the cutout passage part 126d communicate with each other at the inner side, the cutout passage part 126e and the cutout passage part 126h communicate with each other at the inner side, the cutout passage part 126f and the cutout passage part 126g communicate with each other at the inner side, and the cutout passage part 126j and the cutout passage part 126k communicate with each other at the inner side.

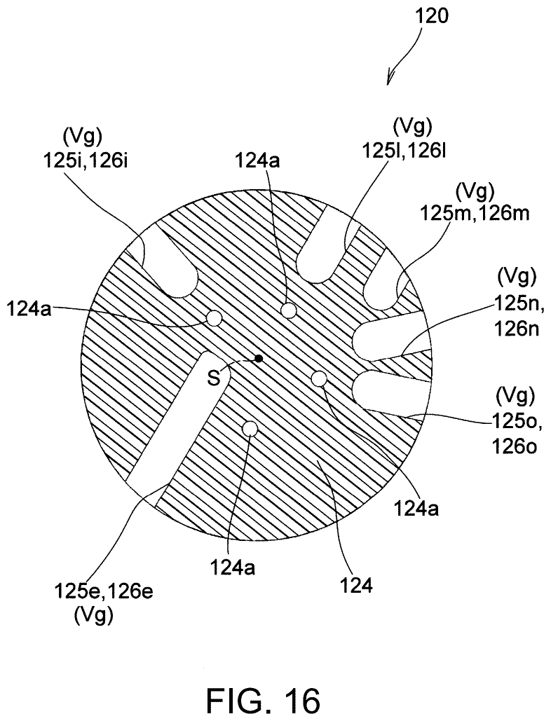

Furthermore, as shown in FIG. 16, the cutout passage part 125e and the cutout passage part 126e, the cutout passage part 125i and the cutout passage part 126i, the cutout passage part 125l and the cutout passage part 126l, the cutout passage part 125m and the cutout passage part 126m, the cutout passage part 125n and the cutout passage part 126n, and the cutout passage part 125o and the cutout passage part 126o are each formed as a vertical groove passage part Vg in which they communicate with each other in the axis S direction.

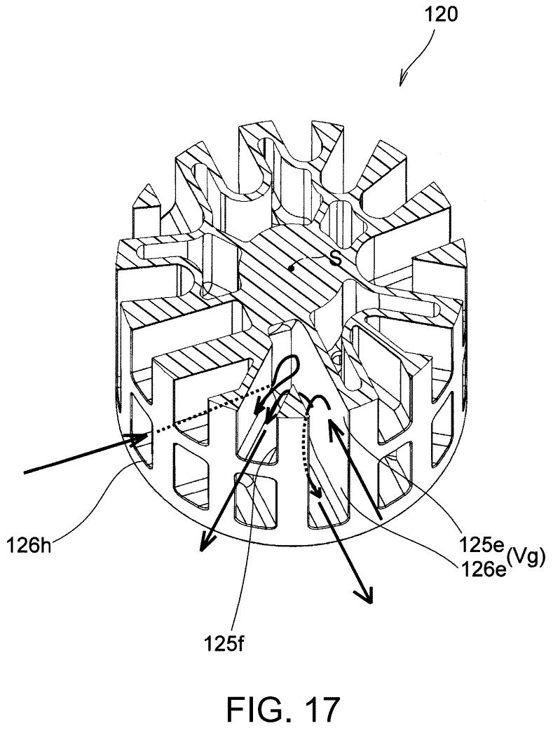

In the above configuration, as indicated by arrows in FIG. 17, the cooling water flows into the cutout passage part 125e and then flows out from the cutout passage part 126e and the cutout passage part 125f, and the cooling water flows in from the cutout passage part 126h and then flows out from the cutout passage part 126e and the cutout passage part 125f.

That is, the multi-way switching valve 120 is formed to include: the vertical groove passage part Vg that allows the cutout passage part 125e of the first outer circumferential surface 120a₁ and the cutout passage part 126e of the second outer circumferential surface 120a₂ to communicate with each other; and the cutout passage part 125f of the first outer circumferential surface 120a₁ and the cutout passage part 126h of the second outer circumferential surface 120a₂ that are formed to communicate with the vertical groove passage part Vg.

As shown in FIG. 8, the abutting part 127 abuts against the stopper 101f formed on the bottom wall 101d of the cylindrical recess 101 of the base member 100 to restrict the rotation of the multi-way switching valve 120. That is, the multi-way switching valve 120 rotates clockwise CW and counterclockwise CCW about the axis S and abuts against the stopper 101f, and further rotation of the multi-way switching valve 120 is restricted.

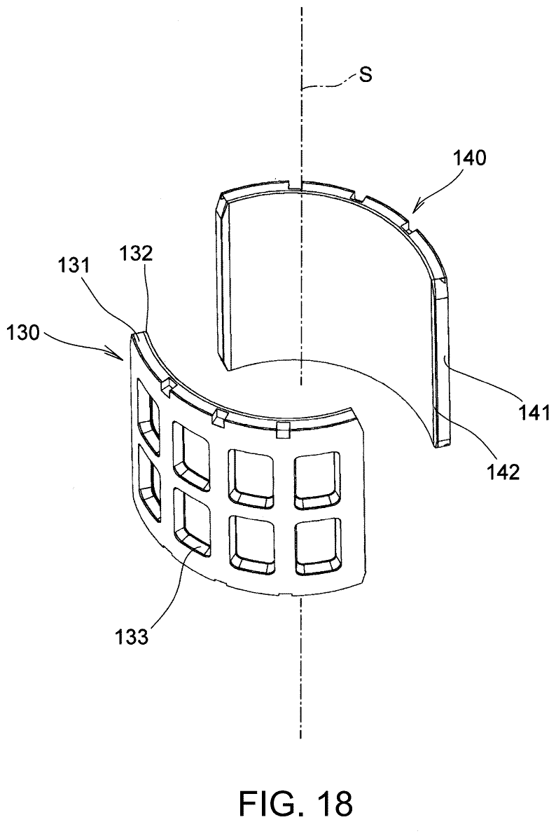

As shown in FIG. 18, the seal member 130 is assembled in an arc plate shape centered on the axis S, and includes: an outer arc plate 131 formed of a rubber material; an inner arc plate 132 formed of a crystalline resin material, for example, a fluororesin such as polytetrafluoroethylene (PTFE); and multiple (herein, eight) rectangular holes 133 in a substantially rectangular shape.

The multiple rectangular holes 133 are respectively formed to correspond to the multiple openings (the first inlet 102a, the first outlet 103a, the second inlet 104a, the second outlet 105a, the third inlet 106a, the third outlet 107a, the fourth inlet 108a, and the fourth outlet 109a) formed on the inner circumferential surface 101a of the cylindrical recess 101.

As shown in FIG. 8 and FIG. 19, the seal member 130 is disposed between the inner circumferential surface 101a of the cylindrical recess 101 of the base member 100 and the outer circumferential surface 120a of the multi-way switching valve 120, at a position corresponding to the angular range θ1 between the pair of protruding strips 101b.

As shown in FIG. 18, the spacer member 140 is assembled in an arc plate shape centered on the axis S, and includes an outer arc plate 141 formed of a rubber material and an inner arc plate 142 formed of a crystalline resin material, for example, a fluororesin such as polytetrafluoroethylene (PTFE).

As shown in FIG. 8 and FIG. 19, the spacer member 140 is disposed between the inner circumferential surface 101a of the cylindrical recess 101 of the base member 100 and the outer circumferential surface 120a of the multi-way switching valve 120, at a position corresponding to the angular range θ2 between the pair of protruding strips 101c, that is, in a region on the opposite side of the seal member 130 across the axis S.

In this manner, since the seal member 130 and the spacer member 140 are disposed to be opposed to each other across the axis S, an aligning action for the multi-way switching valve 120 can be achieved, and compared to the case where the seal member is disposed over the entire circumference, sliding resistance can be reduced, and the driving force for the multi-way switching valve 120 can be reduced.

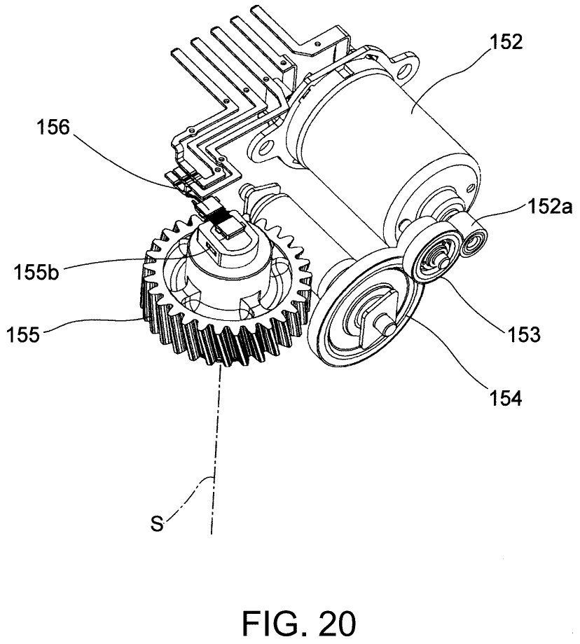

As shown in FIG. 19 and FIG. 20, the drive unit 150 includes a housing 151, a motor 152 having a drive gear 152a, reduction gears 153 and 154, a gear 155, and a hall IC 156.

The housing 151 surrounds the entire drive unit 150 except for a connection hole 155a of the gear 155, is constituted by a housing body 151a and a housing cover 151b, and, as shown in FIG. 19, includes three bosses 151a₁ through which the screws b2 pass.

The motor 152 is, for example, a DC motor, and is driven by the low-voltage battery.

The gear 155 includes a connection hole 155a to which the end 121b of the rotating shaft is connected, and a detected part 155b that is embedded and includes a permanent magnet or the like.

The hall IC 156 is disposed on the housing cover 151b to be opposed to the detected part 155b, and is configured to detect a rotational position of the multi-way switching valve 120.

The drive unit 150 having the above configuration is joined to the outer side of the cover member 110 from the axis S direction, and is fixed to the cover member 110 by the screws b2.

The water pump 160 is an electric centrifugal pump driven by the low-voltage battery, and, as shown in FIG. 5, includes a fitting flange 161 and two bosses 161a through which screws b1 pass. The water pump 160 is disposed in the first pump accommodating recess 102c of the base member 100 from the axis S direction, and the fitting flange 161 is joined to the flange 102c₁ to be fixed to the base member 100 by the screws b1.

The water pump 170 is an electric centrifugal pump driven by the low-voltage battery, and, as shown in FIG. 5, includes a fitting flange 171 and two bosses 171a through which the screws b1 pass. The water pump 170 is disposed in the second pump accommodating recess 104c of the base member 100 from the axis S direction, and the fitting flange 171 is joined to the flange 104c₁ to be fixed to the base member 100 by the screws b1.

The reservoir tank 180 passes cooling water therethrough to adjust an internal pressure, which fluctuates in response to temperature changes in the cooling water, and, as shown in FIG. 5, includes a passage part 181 forming an internal passage (not shown) communicating with the branch port 105c, and two bosses 182 through which the screws b1 pass. The reservoir tank 180 is joined to communicate with the branch port 105c from the axis S direction, and is fixed to the base member 100 by the screws b1 via the bosses 182.

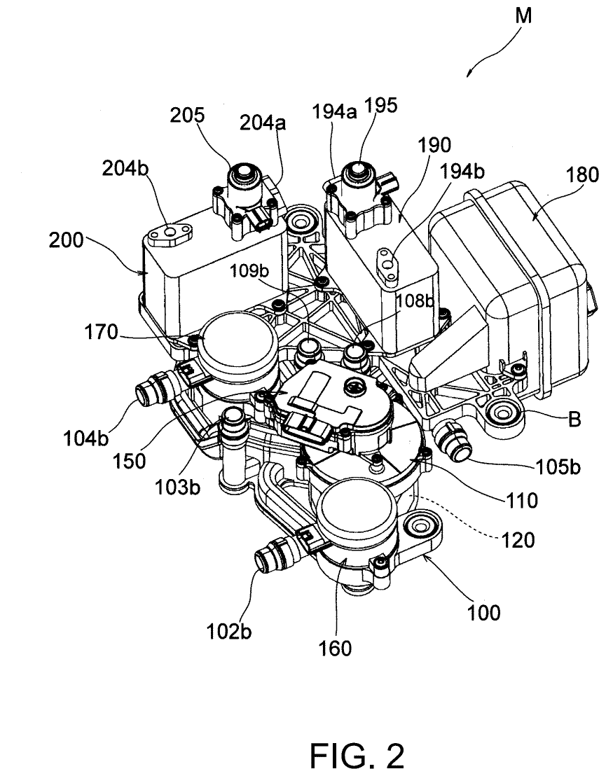

As shown in FIG. 1 and FIG. 2, the first refrigerant-heat medium heat exchanger 190 performs heat exchange between the refrigerant flowing through the refrigerant passage Rp and the cooling water flowing through the second heat medium passage Fp₂, and is disposed in the base member 100 downstream of the reservoir tank 180 of the second outlet side passage 105.

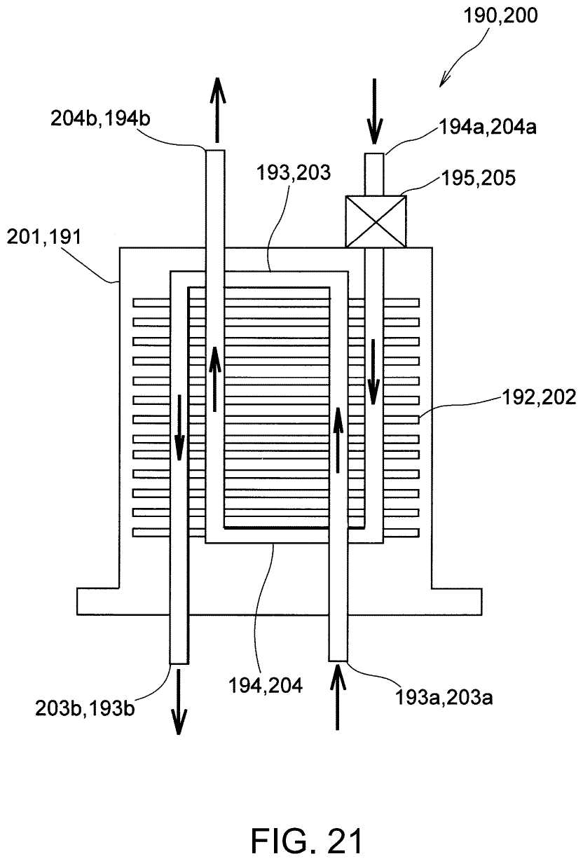

As shown in FIG. 5 and FIG. 21, the first refrigerant-heat medium heat exchanger 190 includes: a housing 191; a heat exchange part 192 composed of multiple metal plates with high thermal conductivity arranged within the housing 191; an intermediate passage 193 forming a part of the second heat medium passage Fp₂, that is, the second outlet side passage 105; a first refrigerant passage 194 forming a part of the refrigerant passage Rp; and an on-off valve 195 disposed upstream of the first refrigerant passage 194.

The housing 191 includes four bosses 191a through which the screws b1 pass, an inlet joint part 193a and an outlet joint part 193b of the intermediate passage 193, and an inlet connection part 194a and an outlet connection part 194b of the first refrigerant passage 194.

The on-off valve 195 is a solenoid valve driven by the low-voltage battery, and opens and closes the upstream side of the first refrigerant passage 194.

As shown in FIG. 1 and FIG. 2, the second refrigerant-heat medium heat exchanger 200 performs heat exchange between the refrigerant flowing through the refrigerant passage Rp and the cooling water flowing through the third heat medium passage Fp₃, and is disposed in the base member 100 between the third inlet side passage 106 and the third outlet side passage 107.

As shown in FIG. 5 and FIG. 21, the second refrigerant-heat medium heat exchanger 200 includes: a housing 201; a heat exchange part 202 composed of multiple metal plates with high thermal conductivity arranged within the housing 201; an intermediate passage 203 connecting the third inlet side passage 106 and the third outlet side passage 107; a second refrigerant passage 204 forming a part of the refrigerant passage Rp; and an expansion valve 205 disposed upstream of the second refrigerant passage 204.

The housing 201 includes four bosses 201a through which the screws b1 pass, an inlet joint part 203a and an outlet joint part 203b of the intermediate passage 203, and an inlet connection part 204a and an outlet connection part 204b of the second refrigerant passage 204.

The expansion valve 205 is a solenoid valve driven by the low-voltage battery, and opens the upstream side of the second refrigerant passage 204 to expand the refrigerant.

Next, an assembly work of the multi-way switching valve device M having the above configuration will be described.

As shown in FIG. 5, the base member 100, the cover member 110, the multi-way switching valve 120, the seal member 130, the spacer member 140, the drive unit 150, the water pumps 160 and 170, the reservoir tank 180, the first refrigerant-heat medium heat exchanger 190, the second refrigerant-heat medium heat exchanger 200, the O-rings Sr₁ and Sr₂, and the multiple screws b1 and b2 are prepared in advance.

First, the seal member 130 and the spacer member 140 are respectively disposed between the pairs of protruding strips 101b and 101c in the cylindrical recess 101 of the base member 100 from the axis S direction.

Next, the multi-way switching valve 120 with the O-ring Sr₂ attached is inserted into the cylindrical recess 101 from the axis S direction, with the end 121a inserted into the bearing recess 101e.

Next, the O-ring Sr₁ is fitted into the annular seal groove 101h of the flange 101g, and the cover member 110 is joined to the flange 101g of the base member 100 from the axis S direction to be fixed by the screws b2. In this assembled state, the end 121b of the multi-way switching valve 120 is exposed to outside through the circular hole 111.

Next, the drive unit 150 is brought close to the cover member 110 from the axis S direction, and with the end 121b fitted into the connection hole 155a of the gear 155, the drive unit 150 is fixed to the cover member 110 by the screws b2.

Next, the water pump 160 is fitted into the first pump accommodating recess 102c of the base member 100 from the axis S direction and is fixed by the screws b1.

Next, the water pump 170 is fitted into the second pump accommodating recess 104c of the base member 100 from the axis S direction and is fixed by the screws b1.

Next, the reservoir tank 180 is joined to the base member 100 from the axis S direction to communicate with the branch port 105c and is fixed by the screws b1.

Next, the first refrigerant-heat medium heat exchanger 190 is joined to the base member 100 from the axis S direction such that the two division ports 105d and 105e and the intermediate passage 193 communicate with each other, and the first refrigerant-heat medium heat exchanger 190 is fixed by the screws b1.

Next, the second refrigerant-heat medium heat exchanger 200 is joined to the base member 100 from the axis S direction such that the third downstream port 106b and the third upstream port 107b communicate with the intermediate passage 203, and the second refrigerant-heat medium heat exchanger 200 is fixed by the screws b1.

The assembly sequence is not limited to the above procedure, and other procedures may also be adopted.

In this manner, since various components (the cover member 110, the multi-way switching valve 120, the seal member 130, the spacer member 140, the drive unit 150, the water pumps 160 and 170, the reservoir tank 180, the first refrigerant-heat medium heat exchanger 190, and the second refrigerant-heat medium heat exchanger 200) can be assembled to the base member 100 from one side in the axis S direction, steps during assembly can be reduced, and thus assembly man-hours can be reduced.

In addition, by adopting the method of assembling from one side in the axis S direction, multiple passages (the first inlet side passage 102, the first outlet side passage 103, the second inlet side passage 104, the second outlet side passage 105, the third inlet side passage 106, the third outlet side passage 107, the fourth inlet side passage 108, and the fourth outlet side passage 109) can be configured radially around the cylindrical recess 101 and integrally formed in the base member 100, and consolidation of the arrangement structure, reduction in the number of components, thinning of the device in the axis S direction, etc. can be achieved.

Next, operations of the temperature adjustment system including the multi-way switching valve device M will be described.

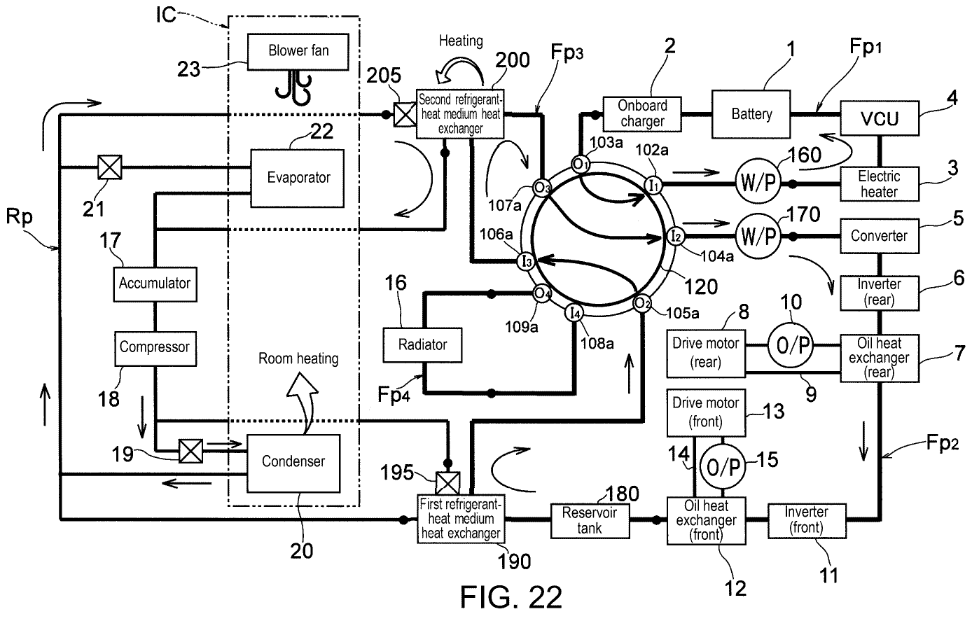

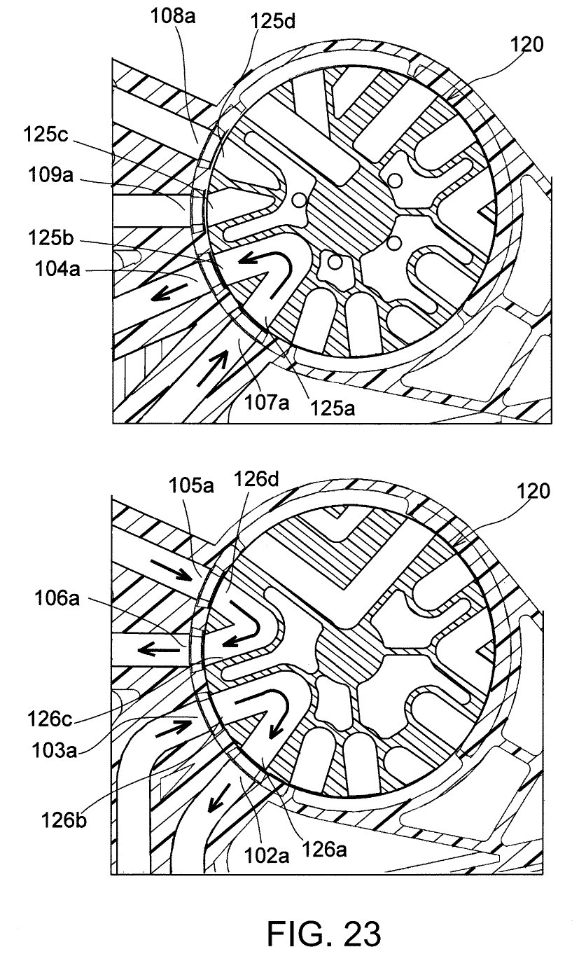

When the multi-way switching valve 120 is at a first switching position, as shown in FIG. 22 and FIG. 23, with the first outlet 103a (outlet O₁) and the first inlet 102a (inlet I₁) respectively opposed to the cutout passage parts 126b and 126a and connected, the first outlet side passage 103 and the first inlet side passage 102 are caused to communicate with each other. With the third outlet 107a (outlet O₃) and the second inlet 104a (inlet I₂) respectively opposed to the cutout passage parts 125a and 125b and connected, the third outlet side passage 107 and the second inlet side passage 104 are caused to communicate with each other. With the second outlet 105a (outlet O₂) and the third inlet 106a (inlet I₃) respectively opposed to the cutout passage parts 126d and 126c and connected, the second outlet side passage 105 and the third inlet side passage 106 are caused to communicate with each other. With the fourth inlet 108a (inlet I₄) and the fourth outlet 109a (outlet O₄) respectively opposed to the cutout passage parts 125d and 125c and connected, the fourth inlet side passage 108 and the fourth outlet side passage 109 are closed.

Thus, the first heat medium passage Fp₁ forms a closed loop passage, and the second heat medium passage Fp₂ and the third heat medium passage Fp₃ are connected in series to form a closed loop passage. Accordingly, by energizing the electric heater 3 to generate heat, the cooling water in the first heat medium passage Fp₁ can be heated, and the battery 1 can be heated by the heated cooling water.

In addition, the cooling water heated by the heat generated from the rear drive motor 8 and the front drive motor 13 (and the heat generated from the converter 5 and the inverters 6 and 11) can be directed to the third heat medium passage Fp₃.

Therefore, as an operation mode 1, with the on-off valve 195 and the expansion valve 21 closed (OFF) and the on-off valve 19 opened (ON), by activating the compressor 18 and opening the expansion valve 205, the refrigerant is heated by the cooling water in the second refrigerant-heat medium heat exchanger 200, and the vehicle cabin IC can be heated by the heat released from the condenser 20. In this operation mode 1, in the case where the outside air temperature is low, for example, in an environment of −10° C. or below, the battery 1 can be heated to an appropriate temperature while suppressing power consumption of the battery 1, and the exhaust heat generated by the drive motors can be recovered to heat the refrigerant to improve the heating efficiency in the vehicle cabin IC.

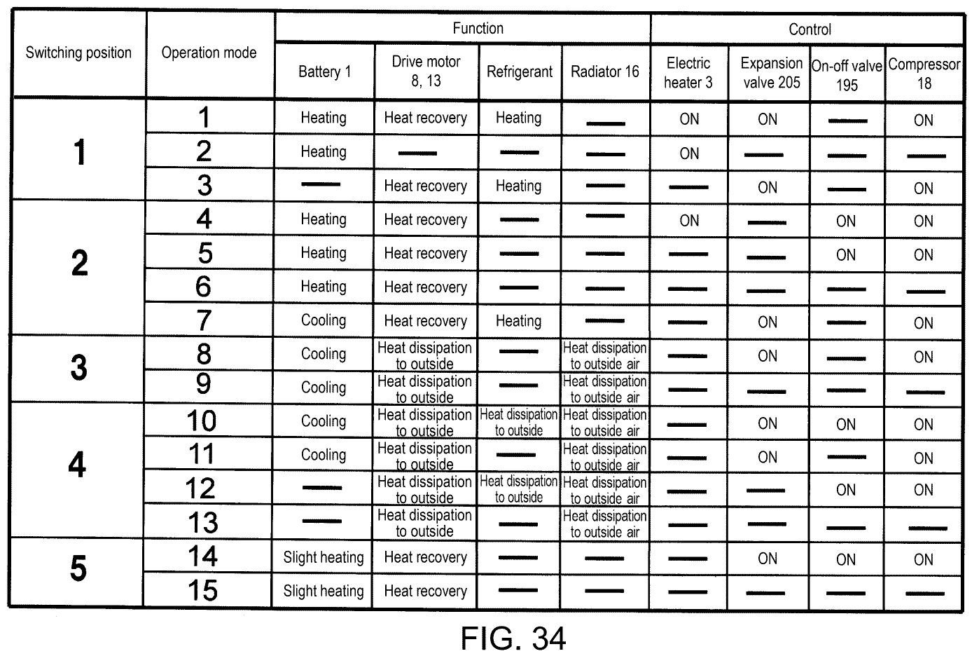

In addition, at the first switching position, as shown in FIG. 34, operation modes 2 and 3 are set as other operation modes.

In the operation mode 2, with the electric heater 3 set to ON, the on-off valve 195 of the first refrigerant-heat medium heat exchanger 190 set to OFF, the expansion valve 205 of the second refrigerant-heat medium heat exchanger 200 set to OFF, and the compressor 18 set to OFF, the battery 1 is heated.

In the operation mode 3, with the electric heater 3 set to OFF, the expansion valve 205 of the second refrigerant-heat medium heat exchanger 200 set to ON, and the compressor 18 set to ON, the refrigerant is heated.

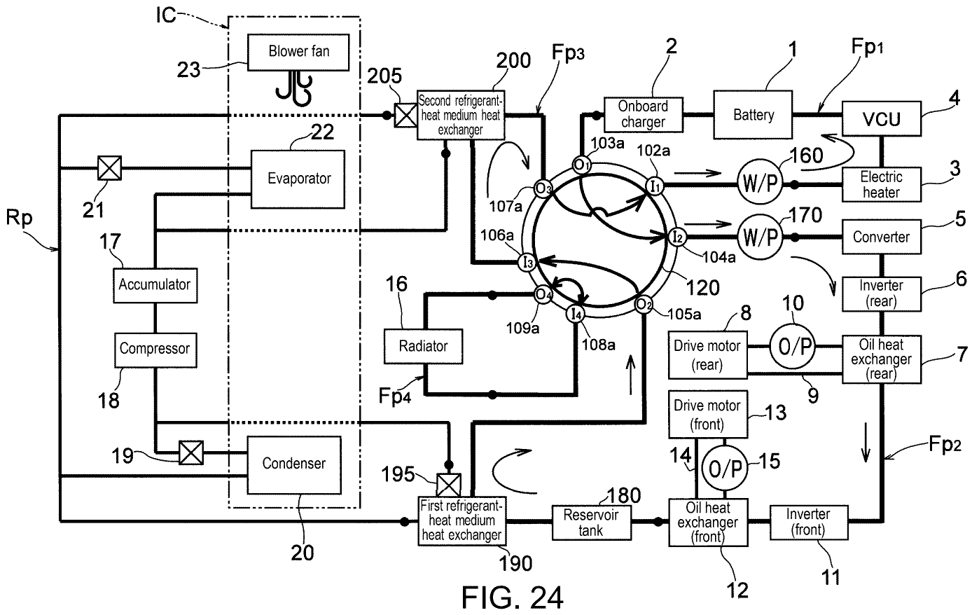

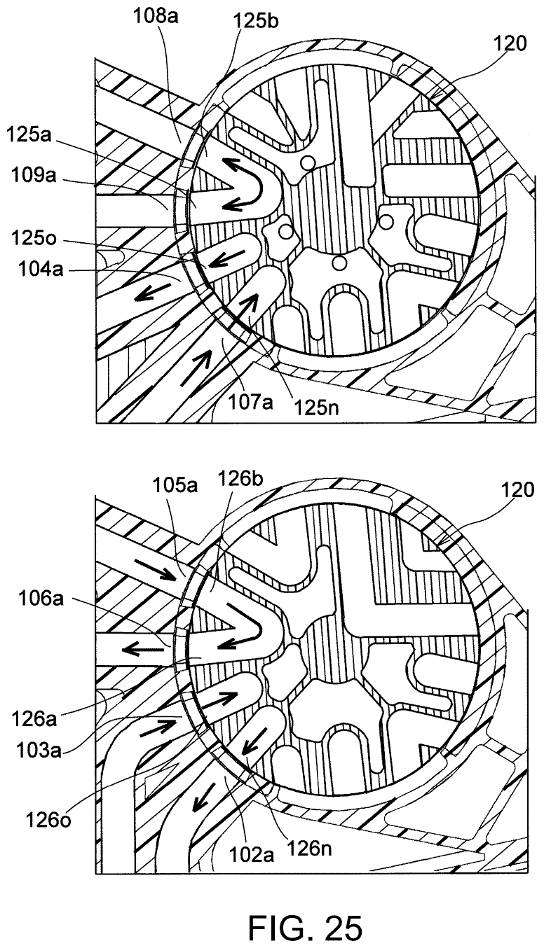

When the multi-way switching valve 120 is at a second switching position, as shown in FIG. 24 and FIG. 25, with the first outlet 103a (outlet O₁) and the second inlet 104a (inlet I₂) respectively opposed to the cutout passage parts 126o and 125o and connected, the first outlet side passage 103 and the second inlet side passage 104 are caused to communicate with each other. With the third outlet 107a (outlet O₃) and the first inlet 102a (inlet I₁) respectively opposed to the cutout passage parts 125n and 126n and connected, the third outlet side passage 107 and the first inlet side passage 102 are caused to communicate with each other. With the second outlet 105a (outlet O₂) and the third inlet 106a (inlet I₃) respectively opposed to the cutout passage parts 126b and 126a and connected, the second outlet side passage 105 and the third inlet side passage 106 are caused to communicate with each other. With the fourth inlet 108a (inlet I₄) and the fourth outlet 109a (outlet O₄) respectively opposed to the cutout passage parts 125b and 125a and connected, the fourth inlet side passage 108 and the fourth outlet side passage 109 are caused to communicate with each other.

Therefore, the first heat medium passage Fp₁, the second heat medium passage Fp₂ and the third heat medium passage Fp₃ are connected in series to form a closed loop passage, and the cooling water circulates through the closed loop passage. Since the fourth heat medium passage Fp₄ forms a closed loop passage with the fourth inlet 108a and the fourth outlet 109a connected, circulation of the cooling water to the radiator 16 does not occur.

At the second switching position, as shown in FIG. 34, operation modes 4 to 7 are set.

In the operation mode 4, with the electric heater 3 set to ON, the on-off valve 195 of the first refrigerant-heat medium heat exchanger 190 set to ON, the expansion valve 205 of the second refrigerant-heat medium heat exchanger 200 set to OFF, and the compressor 18 set to ON, the first refrigerant-heat medium heat exchanger 190 is caused to function as a liquid cooled condenser to heat the cooling water by the electric heater 3 and the refrigerant and heat the battery 1.

In the operation mode 5, with the electric heater 3 set to OFF, the on-off valve 195 of the first refrigerant-heat medium heat exchanger 190 set to ON, the expansion valve 205 of the second refrigerant-heat medium heat exchanger 200 set to OFF, and the compressor 18 set to ON, the first refrigerant-heat medium heat exchanger 190 is caused to function as a liquid cooled condenser to heat the cooling water by the refrigerant and heat the battery 1.

In the operation mode 6, with the electric heater 3 set to OFF, the on-off valve 195 of the first refrigerant-heat medium heat exchanger 190 set to OFF, the expansion valve 205 of the second refrigerant-heat medium heat exchanger 200 set to OFF, and the compressor 18 set to OFF, the cooling water is heated only by the heat generated by the heat-generating components (the rear drive motor 8, the front drive motor 13, etc.) to heat the battery 1.

In the operation mode 7, with the electric heater 3 set to OFF, the on-off valve 195 of the first refrigerant-heat medium heat exchanger 190 set to OFF, the expansion valve 205 of the second refrigerant-heat medium heat exchanger 200 set to ON, and the compressor 18 set to ON, the second refrigerant-heat medium heat exchanger 200 is caused to function as a chiller to cool the cooling water and cool the battery 1.

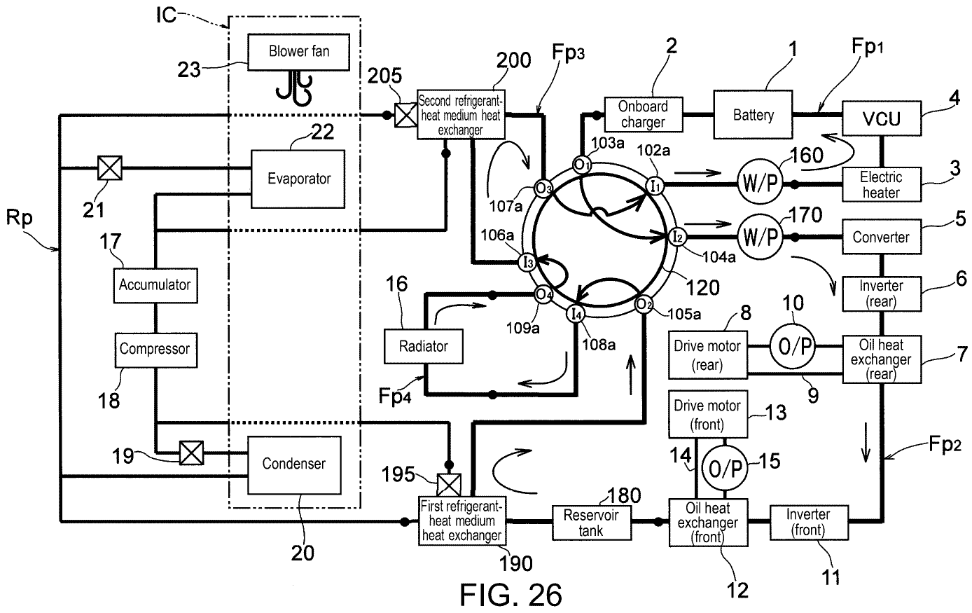

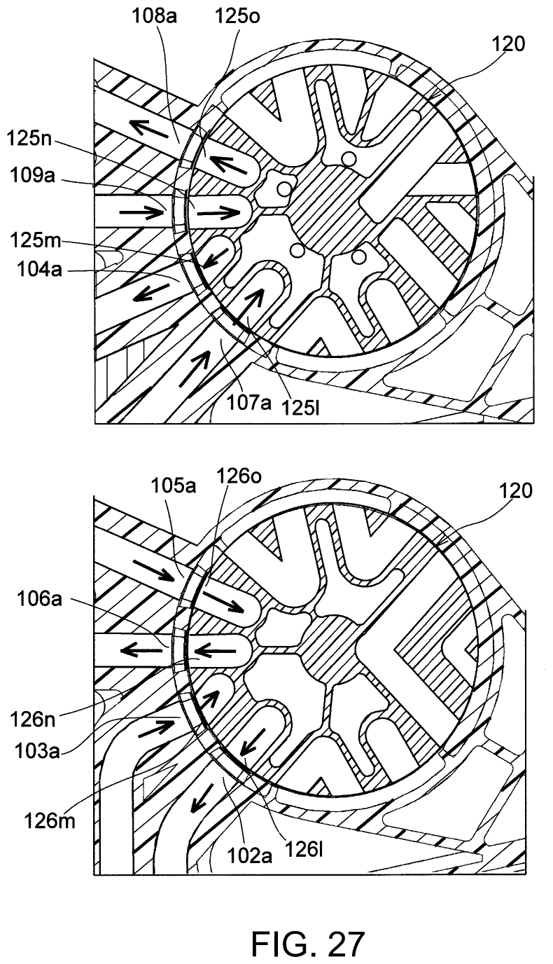

When the multi-way switching valve 120 is at a third switching position, as shown in FIG. 26 and FIG. 27, with the first outlet 103a (outlet O₁) and the second inlet 104a (inlet I₂) respectively opposed to the cutout passage parts 126m and 125m and connected, the first outlet side passage 103 and the second inlet side passage 104 are caused to communicate with each other. With the third outlet 107a (outlet O₃) and the first inlet 102a (inlet I₁) respectively opposed to the cutout passage parts 125l and 126l and connected, the third outlet side passage 107 and the first inlet side passage 102 are caused to communicate with each other. With the second outlet 105a (outlet O₂) and the fourth inlet 108a (I₄) respectively opposed to the cutout passage parts 126o and 125o and connected, the second outlet side passage 105 and the fourth inlet side passage 108 are caused to communicate with each other. With the fourth outlet 109a (outlet O₄) and the third inlet 106a (inlet I₃) respectively opposed to the cutout passage parts 125n and 126n and connected, the fourth outlet side passage 109 and the third inlet side passage 106 are caused to communicate with each other.

Therefore, the first heat medium passage Fp₁, the second heat medium passage Fp₂ the fourth heat medium passage Fp₄, and the third heat medium passage Fp₃ are connected in series to form a closed loop passage, and the cooling water circulates through the closed loop passage.

At the third switching position, as shown in FIG. 34, operation modes 8 and 9 are set.

In the operation mode 8, with the electric heater 3 set to OFF, the on-off valve 195 of the first refrigerant-heat medium heat exchanger 190 set to OFF, the expansion valve 205 of the second refrigerant-heat medium heat exchanger 200 set to ON, and the compressor 18 set to ON, the second refrigerant-heat medium heat exchanger 200 is caused to function as a chiller to cool the cooling water, and the radiator 16 releases heat to outside to cool the battery 1 and the heat-generating components (the rear drive motor 8, the front drive motor 13, etc.).

In the operation mode 9, with the electric heater 3 set to OFF, the on-off valve 195 of the first refrigerant-heat medium heat exchanger 190 set to OFF, the expansion valve 205 of the second refrigerant-heat medium heat exchanger 200 set to OFF, and the compressor 18 set to OFF, the radiator 16 releases heat to outside to cool the battery 1 and the heat-generating components (the rear drive motor 8, the front drive motor 13, etc.).

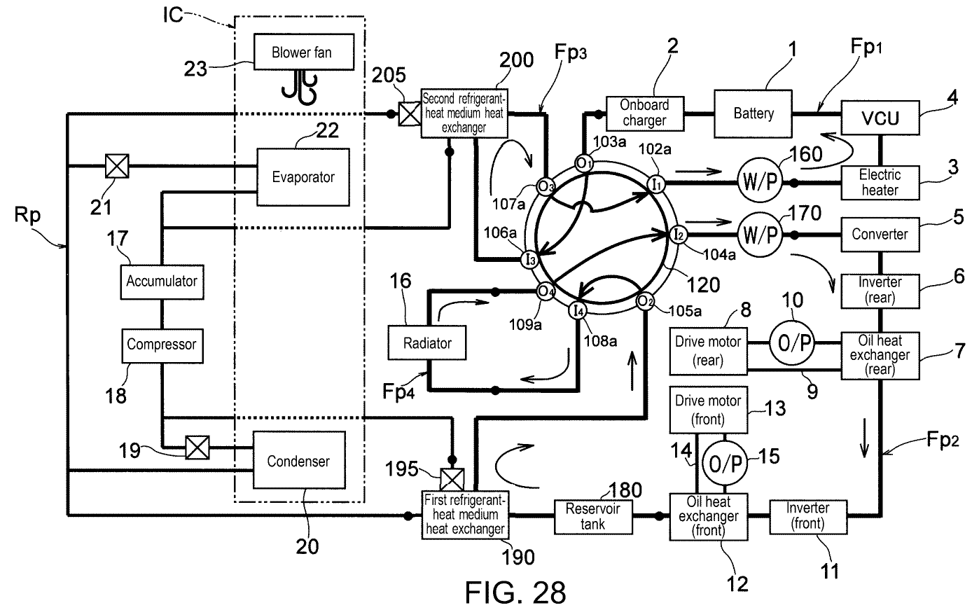

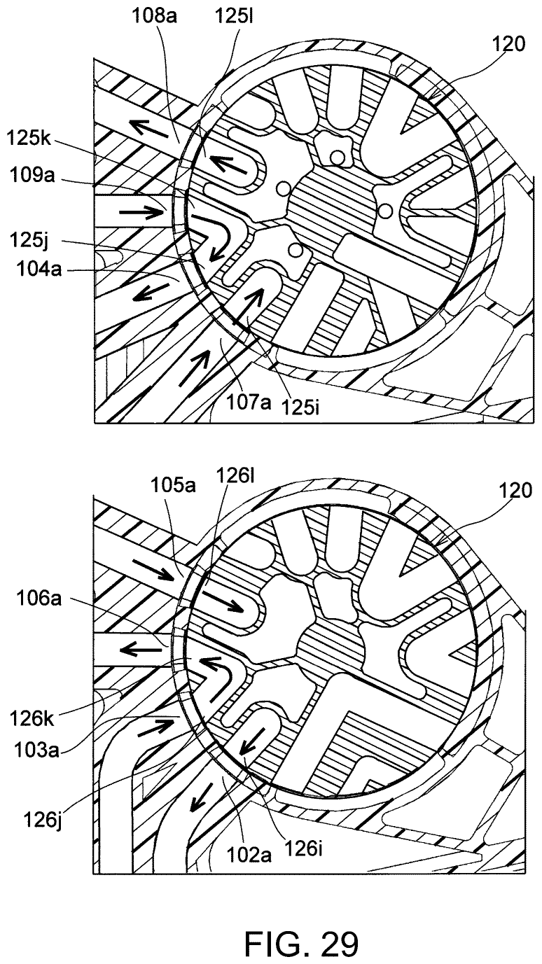

When the multi-way switching valve 120 is at a fourth switching position, as shown in FIG. 28 and FIG. 29, with the first outlet 103a (outlet O₁) and the third inlet 106a (inlet I₃) respectively opposed to the cutout passage parts 126j and 126k and connected, the first outlet side passage 103 and the third inlet side passage 106 are caused to communicate with each other. With the third outlet 107a (outlet O₃) and the first inlet 102a (inlet I₁) respectively opposed to the cutout passage parts 125i and 126i and connected, the third outlet side passage 107 and the first inlet side passage 102 are caused to communicate with each other. With the second outlet 105a (outlet O₂) and the fourth inlet 108a (inlet I₄) respectively opposed to the cutout passage parts 126l and 125l and connected, the second outlet side passage 105 and the fourth inlet side passage 108 are caused to communicate with each other. With the fourth outlet 109a (outlet O₄) and the second inlet 104a (inlet I₂) respectively opposed to the cutout passage parts 125k and 125j and connected, the fourth outlet side passage 109 and the second inlet side passage 104 are caused to communicate with each other.

Therefore, the first heat medium passage Fp₁ and the third heat medium passage Fp₃ are connected in series to form a closed loop passage, the second heat medium passage Fp₂ and the fourth heat medium passage Fp₄ are connected in series to form a closed loop passage, and the cooling water circulates through the respective closed loop passages.

At the fourth switching position, as shown in FIG. 34, operation modes 10 to 13 are set.

In the operation mode 10, with the electric heater 3 set to OFF, the on-off valve 195 of the first refrigerant-heat medium heat exchanger 190 set to ON, the expansion valve 205 of the second refrigerant-heat medium heat exchanger 200 set to ON, and the compressor 18 set to ON, the first refrigerant-heat medium heat exchanger 190 is caused to function as a liquid cooled condenser to release heat from the refrigerant to the cooling water, the second refrigerant-heat medium heat exchanger 200 is caused to function as a chiller to cool the cooling water, and the radiator 16 releases heat to outside to cool the battery 1 and the heat-generating components (the rear drive motor 8, the front drive motor 13, etc.).

In the operation mode 11, with the electric heater 3 set to OFF, the on-off valve 195 of the first refrigerant-heat medium heat exchanger 190 set to OFF, the expansion valve 205 of the second refrigerant-heat medium heat exchanger 200 set to ON, and the compressor 18 set to ON, the second refrigerant-heat medium heat exchanger 200 is caused to function as a chiller to cool the cooling water, and the radiator 16 releases heat to outside to cool the battery 1 and the heat-generating components (the rear drive motor 8, the front drive motor 13, etc.).

In the operation mode 12, with the electric heater 3 set to OFF, the on-off valve 195 of the first refrigerant-heat medium heat exchanger 190 set to ON, the expansion valve 205 of the second refrigerant-heat medium heat exchanger 200 set to OFF, and the compressor 18 set to ON, the first refrigerant-heat medium heat exchanger 190 is caused to function as a liquid cooled condenser to release heat from the refrigerant to the cooling water, and the radiator 16 releases heat to outside to cool the heat-generating components (the rear drive motor 8, the front drive motor 13, etc.).

In the operation mode 13, with the electric heater 3 set to OFF, the on-off valve 195 of the first refrigerant-heat medium heat exchanger 190 set to OFF, the expansion valve 205 of the second refrigerant-heat medium heat exchanger 200 set to OFF, and the compressor 18 set to OFF, the radiator 16 releases heat to outside to cool the heat-generating components (the rear drive motor 8, the front drive motor 13, etc.).

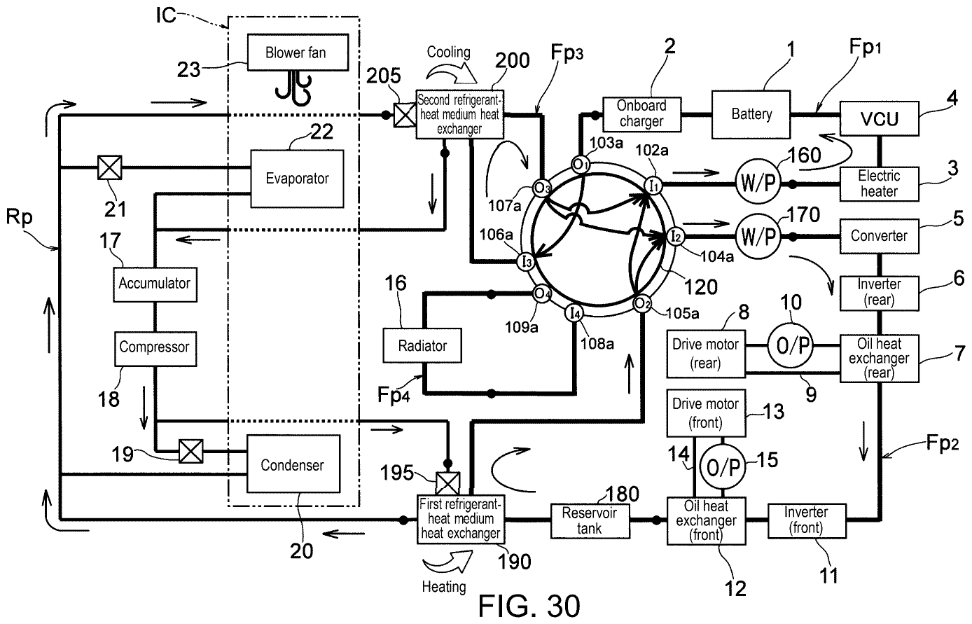

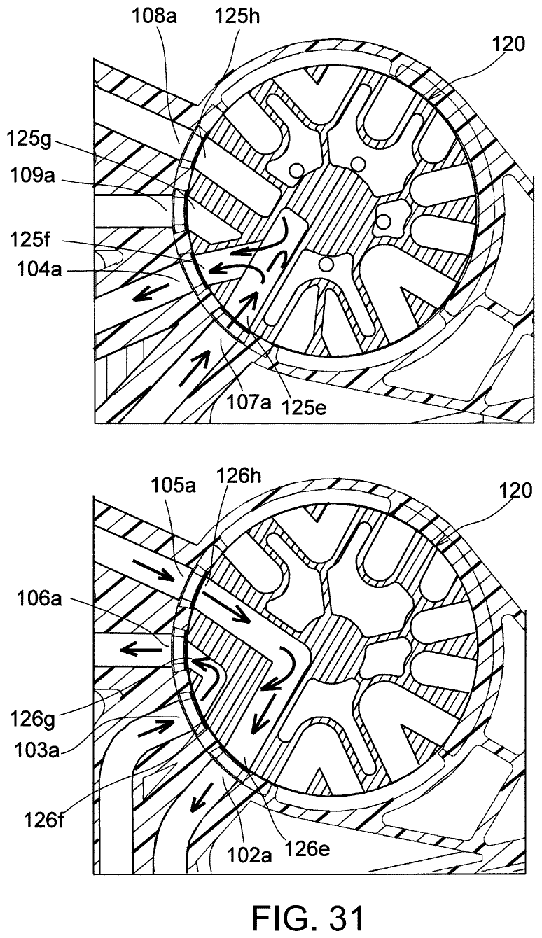

When the multi-way switching valve 120 is at a fifth switching position as a mixing switching position for mixing cooling waters as fluids having different state quantities (herein, temperatures), as shown in FIG. 30 and FIG. 31, with the first outlet 103a (outlet O₁) and the third inlet 106a (inlet I₃) respectively opposed to the cutout passage parts 126f and 126g and connected, the first outlet side passage 103 and the third inlet side passage 106 are caused to communicate with each other. With the third outlet 107a (outlet O₃), the first inlet 102a (inlet I₁), and the second inlet 104a (inlet I₂) respectively opposed to the cutout passage parts 125e, 126e, and 125f and connected, the third outlet side passage 107 is caused to communicate with the first inlet side passage 102 and the second inlet side passage 104. With the second outlet 105a (outlet O₂), the first inlet 102a (inlet I₁), and the second inlet 104a (inlet I₂) respectively opposed to the cutout passage parts 126h, 126e, and 125f and connected, the second outlet side passage 105 is caused to communicate with the first inlet side passage 102 and the second inlet side passage 104. With the fourth inlet 108a (inlet I₄) and the fourth outlet 109a (outlet O₄) respectively opposed to the cutout passage parts 125h and 125g and connected, the fourth inlet side passage 108 and the fourth outlet side passage 109 are closed.

Therefore, the first heat medium passage Fp₁ and the third heat medium passage Fp₃ are connected in series to form a loop passage, the first heat medium passage Fp₁, the third heat medium passage Fp₃, and the second heat medium passage Fp₂ are connected in series to form a loop passage, and the second heat medium passage Fp₂ forms a loop passage that circulates through itself, and the cooling water circulates through the respective loop passages.

At the fifth switching position, as shown in FIG. 34, operation modes 14 and 15 are set.

In the operation mode 14, with the electric heater 3 set to OFF, the on-off valve 195 of the first refrigerant-heat medium heat exchanger 190 set to ON, the expansion valve 205 of the second refrigerant-heat medium heat exchanger 200 set to ON, and the compressor 18 set to ON, the first refrigerant-heat medium heat exchanger 190 is caused to function as a liquid cooled condenser to release heat from the refrigerant to the cooling water, and the second refrigerant-heat medium heat exchanger 200 is caused to function as a chiller to cool the cooling water and moderately heat (slight heating) the battery 1. In this manner, by appropriately heating and cooling the cooling water, the temperature of the battery 1 can be prevented from becoming unstable to maintain the battery 1 at an appropriate management temperature.

In the operation mode 15, with the electric heater 3 set to OFF, the on-off valve 195 of the first refrigerant-heat medium heat exchanger 190 set to OFF, the expansion valve 205 of the second refrigerant-heat medium heat exchanger 200 set to OFF, and the compressor 18 set to OFF, the cooling water is heated by heat recovered from the heat-generating components (the rear drive motor 8, the front drive motor 13, etc.) to moderately heat (slight heating) the battery 1.

In this manner, for example, while suppressing the amount of heat generated by the electric heater 3, heat (exhaust heat) emitted from the heat-generating components (the converter 5, the inverters 6 and 11, the rear drive motor 8, and the front drive motor 13) can be utilized to adjust the cooling water in the first heat medium passage Fp₁ to an optimal temperature and heat (slight heating) the battery 1 to a moderate temperature.

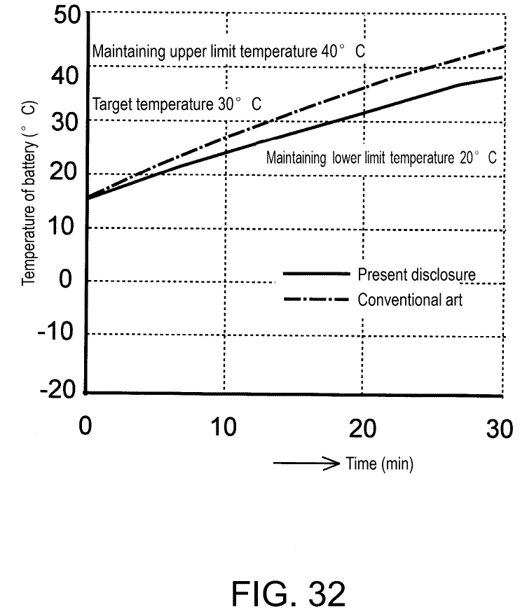

FIG. 32 shows results of simulation comparing stabilization of the temperature of the battery 1, i.e., a length of time that the temperature of the battery 1 can be maintained within a predetermined range centered on a target temperature, between the present disclosure and the conventional art, in the case where a management temperature (target temperature) of the battery 1 is set to 30° C. As can be learned from FIG. 32, the present disclosure can maintain the temperature within the region of the target temperature for a longer period of time compared to the conventional art, and accordingly, stabilization of the temperature of the battery 1 can be achieved.

If the amount of heat generated by the electric heater 3 is increased, the time for the battery 1 to reach the appropriate temperature becomes shorter, but an overshoot exceeding the allowable upper limit temperature may occur, the frequency of switching to the cooling mode may increase, and complication in control and instability of the battery 1 may arise. Therefore, by mixing and flowing cooling waters having different state quantities (temperatures) as described above, the cooling water can be adjusted to an optimal temperature for the battery 1, the overshoot as in the conventional art can be avoided, the switching frequency can be reduced, and the battery 1 can be maintained at a stable temperature.

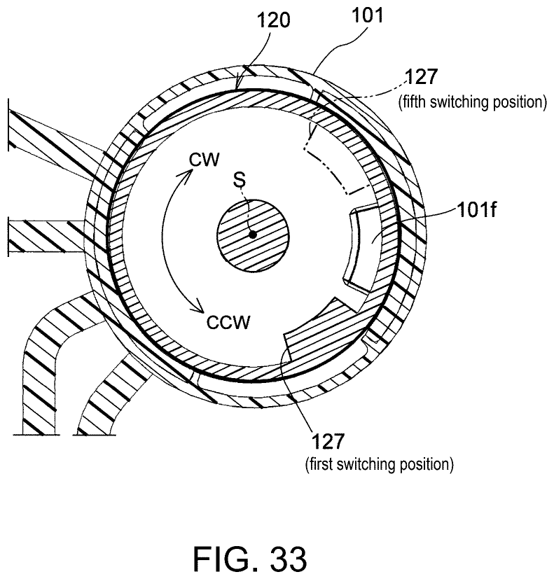

As described above, the multi-way switching valve 120 is appropriately switched to any position among the first switching position to the fifth switching position. As shown in FIG. 33, the position of the abutting part 127 indicated by a solid line corresponds to the first switching position, and upon rotating in one direction (clockwise CW), the position reaches the fifth switching position, which is the position of the abutting part 127 indicated by a double-dot dash line, via the second switching position, the third switching position, and the fourth switching position. In this manner, by rotating clockwise (CW) or counterclockwise (CCW) as appropriate with the stopper 101f as a boundary, the multi-way switching valve 120 is positioned at a desired switching position while the angular position is detected by the hall IC 156.

As described above, the temperature adjustment system of the disclosure includes: a battery 1; a first heat medium passage Fp₁ through which a heat medium for performing heat exchange with the battery 1 flows; a drive motor driving wheels; a second heat medium passage Fp₂ through which a heat medium for performing heat exchange with the drive motor flows; a refrigerant passage Rp through which a refrigerant circulates; a third heat medium passage Fp₃ through which a heat medium for performing heat exchange with the refrigerant flows; and one multi-way switching valve 120 performing opening and closing operations with respect to respective inlets and outlets of the first heat medium passage Fp₁, the second heat medium passage Fp₂, and the third heat medium passage Fp₃. An electric heater 3 heating the heat medium is disposed at the first heat medium passage Fp₁ upstream of the battery 1. At a predetermined mixing switching position, the multi-way switching valve 120 mixes at least the heat medium flowing through the first heat medium passage Fp₁ and the heat medium flowing through the second heat medium passage Fp₂ to mix the heat media having state quantities different from each other.

Accordingly, an overshoot exceeding the upper limit temperature when warming the battery 1 can be suppressed, the frequency of switching between the heating mode and the cooling mode can be reduced to prevent complication in control, and the temperature of the battery 1 can be stabilized.

In addition, at the mixing switching position, the multi-way switching valve 120 causes the heat medium flowing out from the outlet O₁ of the first heat medium passage Fp₁ to flow into the inlet I₁ of the first heat medium passage Fp₁ and the inlet I₂ of the second heat medium passage Fp₂, and causes the heat medium flowing out from the outlet O₂ of the second heat medium passage Fp₂ to flow into the inlet I₁ of the first heat medium passage Fp₁ and the inlet I₂ of the second heat medium passage Fp₂.

Accordingly, the heat medium heated by the electric heater 3 and flowing out from the first heat medium passage Fp₁ can be returned to the first heat medium passage Fp₁ and can also flow into the second heat medium passage Fp₂, and the heat medium heated by the exhaust heat of the drive motor and the like and flowing out from the second heat medium passage Fp₂ (having a different state quantity, e.g., a different temperature) can be returned to the second heat medium passage Fp₂ and can also flow into the first heat medium passage Fp₁.

In addition, at the mixing switching position, the multi-way switching valve 120 connects the outlet O₁ of the first heat medium passage Fp₁ to the inlet I₃ of the third heat medium passage Fp₃, connects the outlet O₃ of the third heat medium passage Fp₃ to the inlet I₁ of the first heat medium passage Fp₁ and the inlet I₂ of the second heat medium passage Fp₂, and connects the outlet of the second heat medium passage Fp₂ to the inlet I₁ of the first heat medium passage Fp₁ and the inlet I₂ of the second heat medium passage Fp₂.

Accordingly, since the heat medium passes through the third heat medium passage Fp₃, in the case where the state quantity (temperature or the like) of the heat medium is changed in the third heat medium passage Fp₃, a heat medium having a different state quantity can be further mixed.

In addition, a first refrigerant-heat medium heat exchanger 190 performing heat exchange between the refrigerant circulating through the refrigerant passage Rp and the heat medium is disposed at the second heat medium passage Fp₂, a second refrigerant-heat medium heat exchanger 200 performing heat exchange between the refrigerant circulating through the refrigerant passage Rp and the heat medium is disposed at the third heat medium passage Fp₃, and a compressor 18 compressing the refrigerant, an on-off valve 195, and an expansion valve 205 are disposed at the refrigerant passage Rp, the compressor 18 being disposed upstream of the first refrigerant-heat medium heat exchanger 190 and downstream of the second refrigerant-heat medium heat exchanger 200, the on-off valve 195 being disposed upstream of the first refrigerant-heat medium heat exchanger 190, and the expansion valve 205 being disposed upstream of the second refrigerant-heat medium heat exchanger 200.

Accordingly, in the first refrigerant-heat medium heat exchanger 190 and the second refrigerant-heat medium heat exchanger 200, the state quantity of the heat medium can be changed, and the heat medium can be configured to have a desired state quantity.

In addition, in the above configuration, the on-off valve 195 is set to allow flow of the refrigerant at the mixing switching position, and the expansion valve 205 is set to allow flow of the refrigerant at the mixing switching position.

Accordingly, the first refrigerant-heat medium heat exchanger 190 can function as a liquid cooled condenser to heat the heat medium flowing through the second heat medium passage Fp₂, and the second refrigerant-heat medium heat exchanger 200 can function as a chiller to cool the heat medium flowing through the third heat medium passage Fp₃.

In addition, the temperature adjustment system further includes a radiator 16 dissipating heat to outside air and a fourth heat medium passage Fp₄ through which a heat medium for performing heat exchange with the outside air via the radiator 16 flows. At the mixing switching position, the multi-way switching valve 120 is set to close an inlet I₄ and an outlet O₄ of the fourth heat medium passage Fp₄.

Accordingly, since the heat medium flowing through the second heat medium passage Fp₂ is not cooled by the radiator 16, the heat of the heat medium can be effectively utilized.

In addition, a first electric pump (water pump 160) pumping the heat medium (cooling water) is disposed at the first heat medium passage Fp₁, and the electric heater 3 is a PTC heater.

Accordingly, the heat medium can be forcibly circulated in the first heat medium passage Fp₁, and based on the self-adjusting characteristics of the PTC heater, the current is limited as the resistance increases together with a temperature rise thereof, so waste of power consumption can be reduced and overheating can be prevented.

In addition, a vehicle control unit 4 performing control of a vehicle and an onboard charger 2 charging the battery 1 from outside are disposed at the first heat medium passage Fp₁ to perform heat exchange with the heat medium.

Accordingly, heat exchange can be performed between the vehicle control unit 4, the onboard charger 2, and the heat medium (cooling water), heat generated therefrom can be effectively recovered, and appropriate cooling can be performed.

In addition, a second electric pump (water pump 170) pumping the heat medium and an oil heat exchanger 7 transferring the heat generated by the drive motor to the heat medium via oil are disposed at the second heat medium passage Fp₂.

Accordingly, the heat medium can be forcibly circulated in the second heat medium passage Fp₂, and the heat generated by the drive motor can be efficiently recovered via oil and transferred to the heat medium.

In addition, a third electric pump circulating the oil is disposed at oil passages 9 and 14 between the drive motor and the oil heat exchanger. In particular, the drive motor includes a rear drive motor 8 driving rear wheels of the vehicle and a front drive motor 13 driving front wheels of the vehicle, and the third electric pump (oil pumps 10 and 15) and the oil heat exchangers 7 and 12 are disposed for each of the rear drive motor 8 and the front drive motor 13.

Accordingly, while forcibly circulating oil, heat generated by both the rear drive motor 8 and the front drive motor 13 can be efficiently recovered via oil and transferred to the heat medium.

In addition, a converter 5 and inverters 6 and 11 are disposed at the second heat medium passage Fp₂ to perform heat exchange with the heat medium.

Accordingly, heat exchange can be performed between the converter 5, the inverters 6 and 11, and the heat medium (cooling water), heat generated therefrom can be effectively recovered, and appropriate cooling can be performed.

In addition, a reservoir tank 180 through which the heat medium passes is disposed at the second heat medium passage Fp₂.

Accordingly, the internal pressure of the second heat medium passage Fp₂, which fluctuates in response to temperature changes in the heat medium (cooling water), can be adjusted, and damage to components due to excessive pressure or the like can be prevented.

In the above embodiment, it has been illustrated that, as the mixing switching position (fifth switching position) of the multi-way switching valve 120, the heat medium passes through the third heat medium passage Fp₃, but the disclosure is not limited thereto. It is also possible to adopt a configuration including a mixing switching position at which the heat medium (cooling water) flowing out from the first outlet 103a of the first heat medium passage Fp₁ is directly returned to the first inlet 102a of the first heat medium passage Fp₁ and is also guided to the second inlet 104a of the second heat medium passage Fp₂ to mix the heat media, and the heat medium (cooling water) flowing out from the second outlet 105a of the second heat medium passage Fp₂ is returned to the second inlet 104a of the second heat medium passage Fp₂ and is also guided to the first inlet 102a of the first heat medium passage Fp₁ to mix the heat media.

In the above embodiment, a PTC heater has been illustrated as the electric heater 3, but the disclosure is not limited thereto, and another electric heater may also be adopted as long as the electric heater generates heat using the battery 1 as a power source.

In the above embodiment, it has been illustrated that the first electric pump (water pump 160) is configured to be disposed at the first heat medium passage Fp₁, but the disclosure is not limited thereto, and it is also possible not to adopt the first electric pump as long as the passage and the structure are configured such that natural circulation occurs due to the temperature gradient of the heat medium.

In the above embodiment, it has been illustrated that the second electric pump (water pump 170) is configured to be disposed at the second heat medium passage Fp₂, but the disclosure is not limited thereto, and it is also possible not to adopt the second electric pump as long as the passage and the structure are configured such that natural circulation occurs due to the temperature gradient of the heat medium.

In the above embodiment, it has been illustrated that the third electric pump (oil pumps 10 and 15) is disposed at the oil passages 9 and 14 between the drive motor and the oil heat exchanger, but the disclosure is not limited thereto, and it is also possible not to adopt the third electric pump as long as the passage and the structure are configured such that natural circulation occurs due to the temperature gradient of the oil.

As described above, the temperature adjustment system of the present disclosure can suppress an overshoot exceeding an upper limit temperature when warming a battery, can reduce a frequency of switching between a heating mode and a cooling mode to prevent complication in control, and can stabilize a temperature of the battery, and therefore is not only applicable to electric vehicles and the like, but is also useful for systems in other fields or other equipment.

What is claimed is:

1. A temperature adjustment system comprising:
a battery;
a first heat medium passage through which a heat medium for performing heat exchange with the battery flows;
a drive motor driving wheels;
a second heat medium passage through which a heat medium for performing heat exchange with the drive motor flows;
a refrigerant passage through which a refrigerant circulates;
a third heat medium passage through which a heat medium for performing heat exchange with the refrigerant flows; and
one multi-way switching valve performing opening and closing operations with respect to respective inlets and outlets of the first heat medium passage, the second heat medium passage, and the third heat medium passage, wherein
an electric heater heating the heat medium is disposed at the first heat medium passage upstream of the battery, and
at a predetermined mixing switching position, the multi-way switching valve mixes at least the heat medium flowing through the first heat medium passage and the heat medium flowing through the second heat medium passage to mix the heat media having state quantities different from each other.

2. The temperature adjustment system as claimed in claim 1, wherein
at the mixing switching position, the multi-way switching valve causes the heat medium flowing out from the outlet of the first heat medium passage to flow into the inlet of the first heat medium passage and the inlet of the second heat medium passage, and causes the heat medium flowing out from the outlet of the second heat medium passage to flow into the inlet of the first heat medium passage and the inlet of the second heat medium passage.

3. The temperature adjustment system as claimed in claim 2, wherein
at the mixing switching position, the multi-way switching valve connects the outlet of the first heat medium passage to the inlet of the third heat medium passage, connects the outlet of the third heat medium passage to the inlet of the first heat medium passage and the inlet of the second heat medium passage, and connects the outlet of the second heat medium passage to the inlet of the first heat medium passage and the inlet of the second heat medium passage.

4. The temperature adjustment system as claimed in claim 3, wherein
a first refrigerant-heat medium heat exchanger performing heat exchange between the refrigerant circulating through the refrigerant passage and the heat medium is disposed at the second heat medium passage,
a second refrigerant-heat medium heat exchanger performing heat exchange between the refrigerant circulating through the refrigerant passage and the heat medium is disposed at the third heat medium passage, and
a compressor compressing the refrigerant, an on-off valve, and an expansion valve are disposed at the refrigerant passage, the compressor being disposed upstream of the first refrigerant-heat medium heat exchanger and downstream of the second refrigerant-heat medium heat exchanger, the on-off valve being disposed upstream of the first refrigerant-heat medium heat exchanger, and the expansion valve being disposed upstream of the second refrigerant-heat medium heat exchanger.

5. The temperature adjustment system as claimed in claim 4, wherein
the on-off valve allows flow of the refrigerant at the mixing switching position, and
the expansion valve allows flow of the refrigerant at the mixing switching position.

6. The temperature adjustment system as claimed in claim 3, further comprising:
a radiator dissipating heat to outside air; and
a fourth heat medium passage through which a heat medium for performing heat exchange via the radiator flows, wherein
at the mixing switching position, the multi-way switching valve closes an inlet and an outlet of the fourth heat medium passage.

7. The temperature adjustment system as claimed in claim 3, wherein
a first electric pump pumping the heat medium is disposed at the first heat medium passage, and
the electric heater is a PTC heater.

8. The temperature adjustment system as claimed in claim 3, wherein
a vehicle control unit performing control of a vehicle and an onboard charger charging the battery from outside are disposed at the first heat medium passage to perform heat exchange with the heat medium.

9. The temperature adjustment system as claimed in claim 3, wherein
a second electric pump pumping the heat medium and an oil heat exchanger transferring heat generated by the drive motor to the heat medium via oil are disposed at the second heat medium passage.

10. The temperature adjustment system as claimed in claim 9, wherein
a third electric pump circulating the oil is disposed at an oil passage between the drive motor and the oil heat exchanger.

11. The temperature adjustment system as claimed in claim 10, wherein
the drive motor comprises a rear drive motor driving rear wheels of a vehicle and a front drive motor driving front wheels of the vehicle, and
the third electric pump and the oil heat exchanger are disposed for each of the rear drive motor and the front drive motor.

12. The temperature adjustment system as claimed in claim 3, wherein
a converter and an inverter are disposed at the second heat medium passage to perform heat exchange with the heat medium.

13. The temperature adjustment system as claimed in claim 3, wherein
a reservoir tank through which the heat medium passes is disposed at the second heat medium passage.
